(19) United States
(12) Patent Application Publication
(10) Pub. No.: US 2023/0331602 A1
(43) Pub. Date: Oct. 19, 2023

(54) ADVANCED OXIDATION USING SUPEROXIDE RADICAL AND FREE AVAILABLE CHLORINE

(71) Applicant: University of Washington, Seattle, WA (US)

(72) Inventors: Michael DODD, Seattle, WA (US); Sin-Yi LIOU, Seattle, WA (US)

(73) Assignee: University of Washington, Seattle, WA (US)

(21) Appl. No.: 18/299,033

(22) Filed: Apr. 11, 2023

Related U.S. Application Data
(60) Provisional application No. 63/330,606, filed on Apr. 13, 2022.

(51) Int. Cl. C02F 1/72; C02F 1/76

(52) U.S. Cl. CPC C02F 1/722; C02F 1/76; C02F 2305/023; C02F 2101/32

(57) ABSTRACT

Embodiments of the present disclosure provide an advanced oxidation composition, use of the composition in methods for advanced oxidation of chemical compounds in a medium comprising one or more chemical compound contaminants, and an apparatus suitable for administering the advanced oxidation composition to a liquid medium. The advanced oxidation composition comprises superoxide radical and free available chlorine, which react to produce hydroxyl radical and reactive chlorine species that effect organic compound degradation in mediums comprising chemical compound contaminants.

### CROSS-REFERENCE(S) TO RELATED APPLICATION(S)

This application claims the benefit of Provisional Application No. 63/330606, filed Apr. 13, 2022, the entire disclosure of which is hereby incorporated by reference herein for all purposes.

### BACKGROUND

In recent decades, tremendous attention has been directed towards the development and application of advanced oxidation processes (AOPs) for degradation of trace organic contaminants during water and wastewater treatment and reuse. AOPs are technologies which utilize radicals to effect organic compound oxidation for the purpose of water and wastewater remediation.

AOPs comprise a wide variety of approaches, including UV irradiation of: hydrogen peroxide (UV/H₂O₂), free available chlorine (UV/FAC), monochloramine (UV/NH₂Cl), and ozone (UV/O₃). Where UV irradiation of free available chlorine (FAC) is used, the FAC predominantly comprises hypochlorous acid (HOCl) and its conjugate base hypochlorite (OCl⁻). Other approaches include ozone (O₃) and H₂O₂ (O₃/H₂O₂), (photo-) Fenton and (photo-)Fenton-like processes, radiolysis, sonolysis, various semiconductor photocatalysis processes, and an array of persulfate-based processes.

The species that has driven almost all of the AOPs in water and wastewater treatments is HO^{⋅}. In all the above approaches, hydroxyl radical (HO^{⋅}) is a key (and often the key) oxidant responsible for contaminant oxidation, with HO^{⋅} reacting non-selectively, and having high second-order rate constants for reactions with most organic, and many inorganic, contaminants.

While many of the AOPs noted can result in highly effective contaminant degradation, they often require specialized capital- and energy-intensive infrastructure. For example, arrays of low- or medium-pressure Hg vapor lamps for UV-driven processes can be required. Separately, for O₃-driven processes, high-capacity O₃ generators are required, which are often accompanied by extensive equipment for liquid- or gas-phase O₂ handling and/or purification, and post-treatment O₃ destruction.

Many such AOPs are also subject to various physical-chemical constraints on process efficiency. For example, hydrodynamics and spatial heterogeneity in light intensity in the case of UV-driven processes, hydrodynamics and mass-transfer limitations on gas-phase O₃ dissolution into solution for O₃-driven processes, mass-transfer limitations on contaminant transport to interfacial reactive sites for heterogeneous photocatalysis processes, and low pH requirements in the case of many (photo-) Fenton and (photo-) Fenton-like approaches.

The reaction between O₂^{⋅-} and FAC has also been proposed as a source of HO^{⋅}. However, there is a void in the literature pertaining to utilization of the O₂^{⋅-}/FAC process as an AOP due to: (1) difficulties in handling O₂^{⋅-}, as it is extremely unstable and can decay rapidly in the aqueous phase under circumneutral conditions; and (2) difficulties in generating sufficiently high concentrations of O₂^{⋅-} for practical application in AOPs.

O₂^{⋅-} can be chemically produced by various approaches, as described herein. However, such methods cannot generate O₂^{⋅-} at the concentrations needed for effective water and wastewater purification applications, specifically, at mM levels.

Some of the foregoing methods produce primarily hydroxyl radical without other reactive species. Other methods can generate reactive species in addition to the hydroxyl radical, such as the reactive chlorine species (RCS): chlorine radical (Cl^{⋅}), chlorine monoxide radical (ClO^{⋅}), and dichloride radical (Cl₂^{⋅-}). Such RCS are also important oxidants and, like the hydroxyl radical, can effectively decompose recalcitrant micropollutants that are not otherwise susceptible to free available chlorine or other “conventional” oxidants (e.g., chlorine dioxide, chloramines, ozone, or permanganate).

Potential markets or end user(s) include: (a) the municipal drinking water and potable water reuse sectors (including small, decentralized scales for systems with 10,000 consumers); (b) individual users interested in enhanced removal of organic contaminants at point-of-use (e.g., at the tap in a user's home or workplace, or for travel/backpacking); and (c) industrial sectors requiring extremely high quality/ultrapure water (e.g., semiconductor production).

Therefore, a need exists for convenient, cost-effective, and highly-efficient options for implementation of AOPs, such as that described herein, which is characterized by high radical exposures, simplicity, rapid time-scales, potential for on-site O₂^{⋅-} generation, and widespread accessibility of FAC and other reagents.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, an advanced oxidation composition is generated, which comprises a superoxide radical and a free available chlorine. The superoxide radical, as a superoxide radical stock solution of an aqueous medium, contacts free available chlorine, as a free available chlorine solution of an aqueous medium. The superoxide radical can be stabilized by a pH of about 11 to about 14 of the superoxide radical stock solution, can be produced at a concentration up to about 3 mM, and has a half-life up to about 5 minutes.

The superoxide radical stock solution can be prepared by generating a solution of KO₂ in an alkaline aqueous medium, or by ultraviolet irradiation of hydrogen peroxide in an alkaline aqueous medium.

The free available chlorine solution can be prepared by generating a solution of sodium hypochlorite in an aqueous medium.

The advanced oxidation composition, generated upon contacting the free available chlorine solution with the superoxide radical stock solution, can produce hydroxyl radical and reactive chlorine species.

In another aspect, the advanced oxidation composition is used in a method wherein the advanced oxidation composition contacts a medium comprising one or more chemical compound contaminants. The hydroxyl radical and reactive chlorine species which are produced can oxidize or oxidatively cleave hydrocarbons, or oxidize atoms of the chemical compound contaminants.

In yet another aspect, an apparatus is described, which is configured for administration of the advanced oxidation composition to a medium comprising one or more chemical compound contaminants. Administration of the advanced oxidation composition effects advanced oxidation of one or more chemical compound contaminants in the medium comprising one or more chemical compound contaminants.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 shows the acid-base speciation of HO₂^{⋅}/O₂^{⋅-} and HOCl/OCl⁻, and theoretical apparent rate constants (kₐₚₚ) for the O₂^{⋅-}/FAC reaction and the HO₂^{⋅}/O₂^{⋅-} disproportionation reaction (based on K_{a,HO2⋅}=10^{-4.8}, K_{a,HOCl}=10^{-7.5}, Eq. 2, and Eq. 13, respectively);

FIG. 2 shows effects of various control treatments and O₂^{⋅-}/FAC treatments on probe compound concentrations in pH 7, 50 mM phosphate buffer containing [NB, BA, DMB]₀=1 μM or [pCBA]₀=1 μM. Solutions were subjected to (from left to right on graph): (i) HO₂^{⋅}/O₂^{⋅-} and H₂O₂/HO₂⁻ only treatment (by single-dose addition of [HO₂^{⋅}/O₂^{⋅-}]₀=20-200 μM; noting that O₂^{⋅-} stocks also contained H₂O₂/HO₂⁻, due to HO₂^{⋅}/O₂^{⋅-} disproportionation), (ii) FAC only treatment (by single-dose addition of [FAC]₀=10-100 μM), (iii) FAC and H₂O₂/HO₂⁻ only treatment (by single-dose addition first of [FAC]₀=10-100 μM and then of [H₂O₂/HO₂⁻]₀=250 μM), (iv) O₂^{⋅-}/FAC treatment with t-BuOH (by single-dose, postmix addition of [HO₂^{⋅}/O₂^{⋅-}]₀=20-200 μM to [FAC]₀=10-100 μM in the presence of [t-BuOH]₀=50 mM), or (v) O₂^{⋅-}/FAC treatment (by single-dose, postmix addition of [HO₂^{⋅}/O₂^{⋅-}]₀=20-200 μM to [FAC]₀=10-100 μM); HO₂^{⋅}/O₂^{⋅-} and H₂O₂/HO₂⁻ only, FAC only, and FAC and H₂O₂/HO₂⁻ only control treatments were evaluated in single experiments, whereas O₂^{⋅-}/FAC treatment experiments (with and without t-BuOH) were conducted in duplicate; error bars represent one standard deviation about the mean of duplicate measurements;

FIG. 3 shows formaldehyde concentrations formed in solutions of pH 7, 50 mM phosphate buffer containing [t-BuOH]₀=50 mM and [FAC]₀=50, 100, or 250 μM following single-dose postmix O₂^{⋅-}/FAC treatment with increasing concentrations of [HO₂^{⋅}/O₂^{⋅-}]₀; all concentrations were background-corrected for low formaldehyde concentrations (<2 μM) observed in controls subjected to HO₂^{⋅}/O₂^{⋅-} and H₂O₂/HO₂⁻ only, FAC only, and H₂O₂/HO₂⁻ only treatments, which arose as impurities from t-BuOH stocks, phosphate salts, and/or Hantzsch method reagents; error bars represent one standard deviation about the mean of duplicate measurements;

FIG. 4A for NB, FIG. 4B for BA, FIG. 4C for DMB, FIG. 4D for OH^{⋅}, FIG. 4E for Cl^{⋅}, and FIG. 4F for ClO^{⋅}/Cl₂^{⋅-}, show effects of [HO₂^{⋅}/O₂^{⋅-}]₀, [FAC]₀, and [HO₂^{⋅}/O₂^{⋅-}]₀/[FAC]₀ ratio on (a) extent of probe compound degradation (Δ[probe]/[probe]₀), and (b) in situ radical exposures (∫₀^{t}[radical]dt), during single-dose, post-mix O₂^{⋅-}/FAC treatment of pH 7, 50 mM phosphate buffer containing [NB, BA, DMB]₀=1 μM; solutions were treated with variable concentrations of [HO₂^{⋅}/O₂^{⋅-}]₀=5-300 μM and [FAC]₀=10-100 μM; and error bars represent one standard deviation about the mean of duplicate measurements;

FIG. 5 shows probe compound concentrations and in situ radical exposures (∫₀^{t}[radical]dt) resulting from multiple-dose postmix and premix O₂^{⋅-}/FAC treatment of pH 7, 50 mM phosphate buffer containing [NB, BA, DMB]₀=1 μM, with or without removal of residual H₂O₂/HO₂⁻, where H₂O₂/HO₂⁻ removal was achieved by either catalase or FAC treatment after each O₂^{⋅-} or O₂^{⋅-}/FAC dose; when using FAC to remove H₂O₂/HO₂⁻, residual H₂O₂/HO₂⁻ concentrations were first measured by the Allen reagent method, after which sufficient FAC was added to scavenge all H₂O₂/HO₂⁻ and leave the desired [FAC] residual in solution for the following O₂^{⋅-} dose; experiments were undertaken by dosing [HO₂^{⋅}/O₂^{⋅-}]₀/[FAC]₀=(50 μM)/(25 μM) four times (4×25 μM); error bars represent one standard deviation about the mean of duplicate measurements;

FIG. 6 shows probe compound concentrations and in situ radical exposures (∫₀^{t}[radical]dt) resulting from single-dose premix O₂^{⋅-}/FAC treatment of SRNOM-amended pH 7, 50 mM phosphate buffer or 50 mM phosphate-buffered natural water samples containing [NB, BA, DMB]₀=1 μM at (a) [HO₂^{⋅}/O₂^{⋅-}]₀/[FAC]₀=(20 μM)/(10 μM) or (b) [HO₂^{⋅}/O₂^{⋅-}]₀[FAC]₀=(75 μM)/(37.5 μM); error bars represent one standard deviation about the mean of duplicate measurements; note: Concentrations of DOC and other solution constituents listed here are the values in solution after dilution with all reagents;

FIGS. 7A and 7B show concentrations of (a) oxyhalides and (b) THMs and HAAs resulting from single- and multiple-dose postmix and/or premix O₂^{⋅-}/FAC treatment, wherein samples for FIG. 7B show organic DBPs collected before and after post-chlorination, wherein “(post)-” in the x-axis indicates the samples were post-chlorinated after O₂^{⋅-}/FAC treatment;

FIG. 8 shows modified O₂^{⋅-}/FAC treatment approaches using O₂^{⋅-} stock solutions generated at pH<13 by KO₂ dissolution or UV irradiation of H₂O₂/HO₂⁻ solutions, and dosed at [HO₂^{⋅}/O₂^{⋅-}]₀/[FAC]₀ ratios of 1 or 2;

FIG. 9 shows a comparison of radical exposures achievable during O₂^{⋅-}/FAC treatment in comparison to the advanced oxidation processes most commonly applied in water and/or wastewater treatment and reuse;

FIG. 10 shows a schematic for implementation of the O₂^{⋅-}/FAC process in water treatment;

FIG. 11 shows relative emission spectra of the KrCl* lamp and relative absorption spectra of 1M NaOH, alkaline H₂O₂ (in 1M NaOH), and O₂^{⋅-}/H₂O₂ mixture (in 1M NaOH);

FIGS. 12A and 12B show a KrCl* lamp setup for generating O₂^{⋅-} stock; and

FIG. 13A shows evolution of [HO₂^{⋅}/O₂^{⋅-}] during continuous photolysis of H₂O₂/HO₂⁻ in 1, 0.1, or 0.05M NaOH solutions at pH 13.9, 13.0 or 12.7, using a KrCl* lamp (222 nm, fluence rate=5.56 mW/cm²); FIG. 13B shows evolution of [H₂O₂/HO₂⁻] during continuous photolysis of H₂O₂/HO₂⁻ in 1, 0.1, or 0.05M NaOH solutions at pH 13.9, 13.0 or 12.7, using a KrCl* lamp (222 nm, fluence rate=5.56 mW/cm²); FIG. 13C shows comparison of [HO₂^{⋅}/O₂^{⋅-}] during continuous photolysis of H₂O₂/HO₂⁻ by a low-pressure Hg lamp (254 nm, fluence rate=39.5 mW/cm²) with that observed during photolysis of H₂O₂/HO₂⁻ by the KrCl* lamp; FIG. 13D shows comparison of [H₂O₂/HO₂⁻] during continuous photolysis of H₂O₂/HO₂⁻ by a low-pressure Hg lamp (254 nm, fluence rate=39.5 mW/cm²) with that observed during photolysis of H₂O₂/HO₂⁻ by the KrCl* lamp; wherein all H₂O₂/HO₂⁻ solutions were prepared using Milli-Q water and NaOH (≥98%, Sigma-Aldrich), filled symbols were results from the KrCl* lamp; and unfilled symbols were results from the LP Hg lamp.

### DETAILED DESCRIPTION

A novel advanced oxidation composition and process is disclosed herein. Generally, the composition utilizes stabilized superoxide radical (O₂^{⋅-}) in a reaction with hypochlorous acid (HOCl) to generate high levels of the potent oxidant hydroxyl radical (HO^{⋅}) and a multitude of reactive chlorine species (RCS). Such composition has been developed for a multitude of purposes, including degrading trace organic contaminants during water and wastewater treatment and/or remediation, as an antimicrobial, and/or applications to detergents.

The process has considerable potential for practical applications in water treatment, including drinking water, wastewater, rain water, well water, and natural bodies of water. Additionally, the applications include potable and nonpotable water and wastewater reuse at a centralized location, and water treatment localized at a point-of-use location.

Disclosed herein is an advanced oxidation composition comprising a superoxide radical and a free available chlorine. The advanced oxidation composition can comprise a superoxide radical stock solution and a free available chlorine solution.

As used herein, the superoxide radical stock solution can comprise a superoxide radical, including HO₂^{⋅}, O₂^{⋅-}, or a mixture of HO₂^{⋅} and O₂^{⋅}, and can be denoted HO₂^{⋅}/O₂^{⋅-}.

The superoxide radical stock solution comprises an aqueous medium, such as a medium comprising water, or a medium comprising water and an agent which increases the pH of the aqueous medium, to yield an alkaline aqueous medium.

The superoxide radical stock solution can be prepared from KO₂ by dissolving solid KO₂ in an alkaline aqueous medium, or by adding an alkaline aqueous medium to solid KO₂. The resulting superoxide radical stock solution has a pH greater than about 11, a pH greater than about 12, or a pH of between about 11 to about 14.

The base of the alkaline aqueous medium can be any base which can render a pH between about 11 to about 14. For example, NaOH, KOH, and/or Ca(OH)₂ can be used to generate an alkaline aqueous medium.

The concentration of KO₂ dissolved in NaOH can be any concentration up to KO₂ solubility limits. For example, the concentration can be about 0.1 mM to about 0.1 M, or from about 0.5 mM to about 10 mM.

Such an aqueous KO₂ solution can yield HO₂^{⋅}, O₂^{⋅-}, or a mixture of HO₂^{⋅} and O₂^{⋅}, as an initial concentration. The actual concentrations of any such species in the aqueous solution can range from approximately the concentration calculated for the initial KO₂, or can be less. For example, the initial concentration of a mixture of HO₂^{⋅} and O₂^{⋅}, denoted [HO₂^{⋅}/O₂^{⋅-}]₀, can be about 5% to about 20%, about 10% to about 20%, about 15% to about 20%, or about 20% of the concentration of KO₂ dissolved in the aqueous medium.

The HO₂^{⋅}/O₂^{⋅-} concentrations resulting from a 0.5 to 10 mM aqueous alkaline KO₂ solution can range from about 0.03 mM to about 3 mM, and can be scaled according to the concentration of aqueous alkaline KO₂ solution used. For example, the HO₂^{⋅}/O₂^{⋅-} concentrations can be between about 30 μM to about 3 mM, about 300 μM to about 3 mM, or about 1 mM to about 3 mM.

The superoxide radical stock solution can be generated by irradiating hydrogen peroxide in an alkaline aqueous medium with ultraviolet irradiation, to form a superoxide radical stock solution having a pH greater than about 11, a pH greater than about 12, or a pH of between about 11 to about 14.

Irradiation of hydrogen peroxide can be effected by methods known in the art for ultraviolet (UV) radiation, such as using a 5 W low pressure Hg UV 254 lamp, or a KrCl* excimer lamp emitting at wavelengths between about 220 to about 225 nm, or around 222 nm.

The HO₂^{⋅}/O₂^{⋅-} concentrations resulting from UV irradiation of an aqueous hydrogen peroxide solution, or of an alkaline hydrogen peroxide solution can be about 30 μM to about 3 mM, about 300 μM to about 3 mM, or about 1 mM to about 3 mM. Such concentrations can be dependent upon the concentration of hydrogen peroxide used, and the pH. For example, a 0.5 mM to about 1 mM superoxide concentration can be achieved for an aqueous hydrogen peroxide solution having at an initial concentration of between about 5 mM to about 20 mM at pH between about 12 to about 13, or at pH between about 12.5 and 12.7.

The superoxide radical stock solution resulting from irradiation of a hydrogen peroxide solution can have a pH greater than about 11, a pH greater than about 12, a pH between about 12 to about 13, or a pH of between about 11 to about 14.

The superoxide radical stock solution can comprise a stabilizing agent. The stabilizing agent can comprise the base which is used to form the alkaline aqueous medium. For example, the stabilizing agent can comprise NaOH, KOH, Ca(OH)₂, a base which causes the pH to be higher than around 11, phosphate, EDTA, distilled water, decarbonation, or a combination thereof.

Inclusion of a stabilizing agent can increase the half-life of a superoxide radical, or of the superoxide radical in the superoxide radical stock solution, and/or prevent decay of the superoxide radical or the superoxide radical in the superoxide radical stock solution.

A pH of between about 11 to about 14, of greater than about 11, of greater than about 12, or between about 12 and about 13, can increase the half-life of a superoxide radical, or of the superoxide radical in the superoxide radical stock solution, and/or prevent decay of the superoxide radical or the superoxide radical in the superoxide radical stock solution.

The superoxide radical in the superoxide radical stock solution can have a half-life of greater than about 30 seconds, of greater than about 1 minute, of greater than about 2 minutes, or of about 1 minute to about 5 minutes.

The advanced oxidation composition can comprise a free available chlorine solution. The free available chlorine solution can comprise a free available chlorine agent in an aqueous medium. For example, the free available chlorine agent can be sodium hypochlorite. The free available chlorine solution can comprise sodium hypochlorite in an aqueous medium. The free available chlorine solution can comprise aqueous sodium hypochlorite diluted in an aqueous medium. The free available chlorine can be hypochlorous acid, hypochlorite, or a mixture thereof. As used herein, a mixture of hypochlorous acid and hypochlorite can be denoted HOCl/OCl⁻. The aqueous medium can be water, and can further comprise a base which increases the pH of the aqueous medium. The free available chlorine solution can comprise an aqueous medium to which a free available chlorine source has already been added, for example a body of water which has been treated with a free available chlorine composition, or municipal water which has been treated with a free available chlorine composition.

The pH of the free available chlorine solution can be greater than about 11, greater than about 12, or between about 11 to about 14.

The absolute concentration of each of the superoxide radical stock solution and the free available chlorine solution can impact the potency of the advanced oxidation composition. The relative concentration of the superoxide radical stock solution in comparison with the free available chlorine solution can also impact the potency of the advanced oxidation composition.

For example, a concentration of the superoxide radical stock solution can be generated having a superoxide radical concentration up to about 3 mM, more than about 300 between about 30 μM and about 3 mM, between about 300 μM and about 3 mM, or between about 1 mM and about 3 mM. A concentration of the free available chlorine solution can be up to about 1.5 mM, more than about 150 μM, between about 15 μM to about 1.5 mM, between about 150 μM to about 1.5 mM, between about 0.5 mM to about 1.5 mM.

The ratio of the concentration of the superoxide radical stock solution relative to the free available chlorine solution can be about 0.2 to about 7.5, can be about 0.5 to about 6, can be about 0.5 to about 4, can be about 1 to about 3, can be about 1.5 to about 2.5, or can be about 2.

The concentration of the superoxide radical in solution relative to the free available chlorine in solution can be about 200 μM relative to about 100 μM.

The amount of superoxide radical, or concentration of the superoxide radical stock solution, and the amount of free available chlorine, or concentration of the free available chlorine solution are selected to comprise an amount which produces an amount of hydroxyl radical and reactive chlorine species that are effective to degrade one or more chemical compound contaminants in a medium.

The superoxide radical stock solution can be combined with, or contacted by, the free available chlorine solution.

The advanced oxidation composition can further comprise an acid (e.g., sulfuric acid or hydrochloric acid). The acid can comprise a strong acid, wherein the acid is completely, or essentially (e.g., more than 99%) dissociated in solution.

The acid can be added to the advanced oxidation composition comprising the superoxide radical stock solution in contact with the free available chlorine solution. The acid can be added to a mixture of the medium comprising one or more chemical compound contaminants and the free available chlorine solution, wherein the acid is added simultaneously with addition of the superoxide radical stock solution. In such embodiments, the acid and the superoxide radical stock solution are not in contact until they contact the medium comprising the one or more chemical compound contaminants and the free available chlorine solution.

The acid can be added simultaneously with the addition of a mixture of the superoxide radical stock solution and the free available chlorine solution to the medium comprising one or more chemical compound contaminants. In such embodiments, the acid and the mixture of the superoxide radical stock solution and the free available chlorine solution are not in contact until they contact the medium comprising the one or more chemical compound contaminants.

The pH of the advanced oxidation composition can be circumneutral (e.g., about pH 6 to about pH 8) after addition of the acid.

As used herein, “premixing” occurs, or a solution is “premixed,” when an alkaline free available chlorine solution is contacted by, or mixed with, a superoxide radical stock solution. In a “premixed” advanced oxidation composition, a superoxide radical stock solution of pH about 11 to about 14 contacts, or is contacted by, a free available chlorine solution of pH about 11 to about 14, to yield an advanced oxidation composition having a pH about 11 to about 14. An acid can be added to such a solution to yield an advanced oxidation composition having a circumneutral pH (e.g., a pH of about 6 to about 8).

As used herein, a “post mix” solution can comprise a superoxide radical stock solution of pH about 11 to about 14, which contacts an aqueous medium in which a free available chlorine has already been added, such as municipal water treated with a free available chlorine source, to yield the advanced oxidation composition in an aqueous medium comprising one or more chemical compound contaminants. An acid can be added simultaneously with addition of the superoxide radical stock solution to the aqueous medium in which a free available chlorine has already been added.

The advanced oxidation composition as described herein can produce hydroxyl radical and reactive chlorine species. Examples of reactive chlorine species which can result from the advanced oxidation composition can include chlorine radical (Cl^{⋅}), chlorine monoxide radical (ClO^{⋅}), and dichloride radical (Cl₂^{⋅-}).

As disclosed herein, an advanced oxidation composition such as the composition described herein is used in a method for advanced oxidation of chemical compounds in or on a medium comprising one or more chemical compound contaminants. In such a method, the medium comprising one or more chemical compound contaminants is contacted with the advanced oxidation composition herein described.

In an embodiment, a post mixed advanced oxidation composition is added to, or contacts, a medium comprising one or more chemical compound contaminants. In an embodiment, a pre-mixed advanced oxidation composition is added to, or contacts, a medium comprising one or more chemical compound contaminants. In yet another embodiment, the advanced oxidation composition is formed within a medium comprising one or more chemical compound contaminants.

In an embodiment, the free available chlorine solution has a pH of about 11 to about 14, the free available chlorine solution is added to a medium comprising one or more chemical compound contaminants, an acid is added simultaneously with addition of the superoxide radical stock solution to the mixture of the medium comprising one or more chemical compound contaminants and the free available chlorine solution, to form an advanced oxidation composition having a pH of about 6 to about 8. In such an embodiment, the acid does not contact the superoxide radical stock solution prior to the addition of each to the mixture of the medium comprising one or more chemical compound contaminants and the free available chlorine solution. The foregoing is an example of a post-mix dosing of a medium comprising one or more chemical compound contaminants.

In an embodiment, the free available chlorine solution has a pH of about 11 to about 14, the superoxide radical stock solution has a pH of about 11 to about 14, and the superoxide radical stock solution is added to the free available chlorine solution to form a premixed solution. The premixed solution can be added simultaneously with an acid to a medium comprising one or more chemical compound contaminants, to form an advanced oxidation composition having a pH of about 6 to about 8. The foregoing is an example of a pre-mix dosing of a medium comprising one or more chemical compound contaminants.

In an embodiment, a medium comprising one or more chemical compound contaminants comprises a free available chlorine agent or the free available chlorine solution, and the advanced oxidation composition is formed in the medium comprising one or more chemical compound contaminants when the superoxide radical stock solution is added to the medium comprising the free available chlorine agent or the free available chlorine solution and the one or more chemical compound contaminants. In such an embodiment, an acid can be added simultaneously with the superoxide radical stock solution to the medium comprising the free available chlorine agent or free available chlorine solution and the one or more chemical compound contaminants.

In the embodiments disclosed herein, contact, mixing, or addition of a solution can occur with rapid mixing.

The calculated exposures of hydroxyl radical from the advanced oxidation composition described herein can be about 5×10⁻¹⁰ M×s for HO^{⋅}, about 10⁻⁹ M×s for the combination of ClO^{⋅} and Cl₂^{⋅-}, and about 10⁻¹¹ M×s for Cl^{⋅}. For a concentration of superoxide radical relative to concentration of free available chlorine ([HO₂^{⋅}/O₂^{⋅-}]₀/[FAC]₀) of about 2, HO^{⋅} exposures can comprise about 5×10⁻¹⁰ M×s, and overall reactive chlorine species (comprising ClO^{⋅}, Cl₂^{⋅-}, and Cl^{⋅}) exposures can comprise up to about 10⁻⁹ M×s.

The medium comprising one or more chemical compound contaminants can be contacted by the advanced oxidation composition one time, more than one time, or can be contacted continuously. For example, a medium can be contacted one time at a determined dose, or determined absolute and relative concentrations of the superoxide radical stock solution and the free available chlorine solution of the advanced oxidation composition.

In an embodiment, the medium comprising one or more chemical compound contaminants can be contacted by the advanced oxidation composition more than one time. For example, the medium can be contacted by the advanced oxidation composition 2 times, 3 times, 4 times, 5 times, 6 times, 7 times, 8 times, 9 times, 10 times, or more than 10 times, or as many times as needed to effect oxidation of the one or more chemical compound contaminants. As used herein, such dosing is termed “multiple dosing.”

In multiple dosing applications of the advanced oxidation composition, the absolute or relative concentrations of the superoxide radical stock solution and the free available chlorine solution can be the same or can be different between each do se of the multiple dosing.

For example, a dosing of any number of times (e.g., 2, 3, 4, 5, 6, 7, 8, 9, 10, or more than 10) can comprise the same concentrations of the superoxide radical stock solution and the free available chlorine solution, or a dosing can comprise different concentrations of the superoxide radical stock solution and the free available chlorine solution between each dosing (e.g., doses 2, 3, and 4 of a 4 dose multiple dosing can comprise the same or different concentrations or amounts of superoxide radical and free available chlorine used).

In an embodiment, the dosing for a multiple dosing administration can comprise the same or different concentrations or amounts of superoxide radical and free available chlorine used for one dosing regimen compared with a different dosing regimen. For example, the concentrations or amounts of superoxide radical and free available chlorine used in a multiple dosing of 2 times can be the same or different as the amounts of superoxide radical and free available chlorine used in a multiple dosing of 4 times.

In an embodiment, a medium comprising one or more chemical compound contaminants can be contacted by the advanced oxidation composition continuously over a period of time.

In an embodiment wherein a medium comprising one or more chemical compound contaminants is contacted more than one time, as in multiple dosing, the method can further comprise a quenching step. In a quenching step, an amount of free available chlorine solution is added to the medium comprising one or more chemical compound contaminants after contacting the medium comprising one or more chemical compound contaminants with the advanced oxidation composition. The quenching step can occur one time or more than one time, and can occur between every dose of a multiple dosing administration, or can occur between only some doses of a multiple dosing administration.

The free available chlorine of the quenching step can consume or deactivate hydrogen peroxide or a H₂O₂/HO₂⁻ composition, or can decrease hydroxyl radical scavenging.

Quenching can yield higher hydroxyl radical amounts than with dosing in which no quenching has occurred. For example, the quenching step can result in about a 10% to about a 20% increase in hydroxyl radical production or exposure.

The medium comprising one or more chemical compound contaminants can be any source of water, municipal water, municipal wastewater, water centralized at a municipality, water localized at a point-of-use, well water, rain water, a natural body of water, water which has been treated, water which has not received a treatment, a microbe, a biofilm, an impermeable surface, a permeable surface, a detergent, or a combination thereof. Examples of an impermeable surface include a desktop, tabletop, or countertop.

In an embodiment, the one or more chemical compound contaminants comprises a hydrocarbon. The hydrocarbon can further comprise one or more heteroatoms, such as O, N, S, and/or P. The hydrocarbon can comprise one or more saturated bonds or one or more unsaturated bonds. Unsaturated chemical bonds can include a double bond, triple bond, aromatic group, or a combination thereof. The product of contact of the one or more chemical compound contaminants with the advanced oxidation composition can comprise an oxidized product, or can comprised a cleavage product (e.g., a ring is opened, a molecule has been cleaved into two or more fragments, and the like). The one or more chemical compound contaminants can comprise a chemical atom which can be oxidized (e.g., N to N—O, C to C═O, and the like). The one or more chemical compound contaminants can comprise one or more chemical compounds, or one or more fragments of the one or more chemical compounds wherein the hydrocarbon can further comprise atoms or functional groups which remain not oxidized, even if they are oxidizable or cleavable under the conditions disclosed herein, or other conditions.

In an embodiment, the method can further comprise monitoring of a decrease in the one or more chemical compound contaminants, monitoring of an increase in a product resulting from oxidation or cleavage of the one or more chemical compound contaminants, or a combination thereof.

This disclosure includes an apparatus configured for advanced oxidation of one or more chemical compound contaminants in a medium comprising one or more chemical compound contaminants, the apparatus comprising: one or more side-stream channels comprising an interior cavity configured for contact with a central contactor channel; one or more inlet ports connected to the interior cavity of the one or more side-stream channels; a central contactor channel in contact with more than one of the one or more side-stream channels, and which is configured to convey the aqueous medium comprising one or more chemical compound contaminants; an ultraviolet source in contact with one of the one or more side-stream channels; and a power source.

The apparatus comprises one of the one or more side-stream channels configured to convey hydrogen peroxide in an alkaline aqueous medium at a pH of about 11 to about 14; a second of the one or more side-stream channels configured to convey a free available chlorine solution comprising a free available chlorine formed from sodium hypochlorite and an alkaline aqueous medium at a pH of about 11 to about 14; and a third of the one or more side-stream channels configured to convey an acid. The hydrogen peroxide in alkaline aqueous medium transits the side-stream channel configured for hydrogen peroxide in alkaline aqueous medium by entry through one of the one or more inlet ports. The free available chlorine solution transits the side-stream channel configured for the free available chlorine solution by entry through one of the one or more inlet ports. The acid transits the side-stream channel configured for the acid by entry through one of the one or more inlet ports. A power source provides power to the ultraviolet source, wherein the ultraviolet source produces ultraviolet light. The hydrogen peroxide in alkaline aqueous medium is irradiated by the ultraviolet light to produce superoxide radical in a superoxide radical stock solution. The superoxide radical stock solution is optionally premixed with the free available chlorine solution by routing the superoxide radical stock solution and the free available chlorine solution through a mixing tee, to form a premixed solution comprising superoxide radical and free available chlorine, having a pH of about 11 to about 14. An aqueous medium flows through the central contactor channel configured to convey the aqueous medium comprising one or more chemical compound contaminants, and the aqueous medium in the central contactor channel is contacted by the superoxide radical stock solution, the free available chlorine solution, and the acid, or is contacted by the premixed solution comprising superoxide radical and free available chlorine, with the acid. The aqueous medium is contacted by the superoxide radical stock solution, the free available chlorine solution, and the acid simultaneously under rapid mixing, or the aqueous medium is contacted by the premixed solution comprising superoxide radical and free available chlorine, with the acid simultaneously under rapid mixing.

The apparatus disclosed herein can be placed in series with one or more existing water treatment systems.

The apparatus disclosed herein can further comprise components which can be used for monitoring flow rate, pressure, temperature, UV lamp operation, superoxide radical stock solution concentration, free available chlorine solution concentration, or which can used for detecting superoxide radical, free available chlorine, hydroxyl radical, reactive chlorine species, organic compound degradation products such as oxidation products, or molecular fragments resulting from cleavage.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in view of the number of reported significant digits, and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

All references cited herein are incorporated by reference. Aspects of the disclosure can be modified, if necessary, to employ the systems, functions, and concepts of the above references and application to provide yet further embodiments of the disclosure. These and other changes can be made to the disclosure in view of the detailed description. In the event any inconsistency exists between the disclosure of the present application and the disclosure(s) of any document incorporated herein by reference, the disclosure of the present application shall govern.

Additional description and details of the present disclosure are shown.

### EXAMPLES

### Example 1

### General Method for Advanced Oxidation

As the general basis for advanced oxidation using a superoxide radical, moderately-stable aqueous superoxide (O₂^{⋅-}) stock solutions were prepared by multiple approaches. Such approaches include dissolution of KO₂ solids, and UV irradiation of hydrogen peroxide. The O₂^{⋅-} produced by such approaches is stabilized at a pH of 11 or greater, or pH of 11-14. The resulting aqueous O₂^{⋅-} stock solutions have a stability half-life (t_{1/2}) on the order of minutes.

Such solutions as described herein were directly added to aqueous free available chlorine (FAC; i.e., HOCl/OCl⁻) at circumneutral pH (e.g. pH 6-8). Aqueous O₂^{⋅-} stocks under conditions of enhanced HO₂^{⋅}/O₂^{⋅-} stability (pH>11) can be easily handled and dosed to receiving solutions already containing FAC. This provides the option of utilizing O₂^{⋅-}/FAC treatment as a means of generating a nearly instantaneous pulse or, alternatively, multiple pulses, of HO_{⋅} and RCS in a process following pre-exposure of a medium to FAC as in disinfection or pre-oxidation. This is much the same way that O₃/H₂O₂ can be used to convert residual O₃ to HO^{⋅} following a prior period of O₃ exposure for disinfection or pre-oxidation.

Alternatively, superoxide solutions were premixed with alkaline FAC, and then acidified to pH 7. This pre-mixing of O₂^{⋅-} and FAC under alkaline conditions provides a unique option in which a combined O₂^{⋅-}/FAC stock can be added directly to a water at circumneutral pH to generate a pulse of HO^{⋅} and RCS for advanced oxidation. Here, the pre-mixed O₂^{⋅-}/FAC stock effectively serves as a ready-made HO^{⋅} and RCS stock. The use of such a pre-mixing approach also presents the opportunity to apply O₂^{⋅-}/FAC treatment to water without subjecting the water to pre-chlorination. This has potential benefits of minimizing halogenated organic DBP formation, and may enable application to waters containing high levels of matrix constituents that would normally prevent maintenance of an FAC residual (e.g., NH₄⁺/NH₃).

The foregoing resulted in contaminant organic compound degradation through the mechanism of in situ-generated HO^{⋅} and RCS.

Radical production was optimal at [HO₂^{⋅}/O₂^{⋅-}]₀/[FAC]₀˜2, with ˜0.8 mol HO^{⋅} formed/mol FAC consumed, and with HO^{⋅} and RCS exposures reaching ˜5×10⁻¹⁰ and ˜10⁻⁹ M×s, respectively. These levels were on par with, or in excess of, the levels achievable using currently-applied AOPs, including UV/H₂O₂, O₃/H₂O₂, and UV/HOCl.

Similar trends were observed when applied to natural waters and organic matter-amended phosphate buffer containing up to 5 mgC/L (mg Carbon/L) of dissolved organic carbon.

Direct formation of regulated disinfection byproducts (DBPs) was minimal, though organic DBP formation can be moderately enhanced during post-chlorination of O₂^{⋅-}/FAC-treated solutions.

### Example 2

### Chemistry of O₂^{⋅-} and O₂^{⋅-}/FAC Reactions

Improvements of AOPs require potential to operate with minimal additional infrastructure, low cost and energy consumption, homogeneous reaction chemistry or minimal mass-transfer limitations, and high efficiency at circumneutral pH. These criteria are achievable through generation of HO^{⋅} from the homogeneous, aqueous-phase reaction of superoxide radical (O₂^{⋅-}) with hypochlorous acid (HOCl) (Eq. 1).

| | | |
|---|---|---|
| HOCl + O₂^{•-} → Cl⁻ + HO^{•} + O₂ | k₁ = 7.5 × 10⁶ M⁻¹s⁻¹ | Equation (1) |

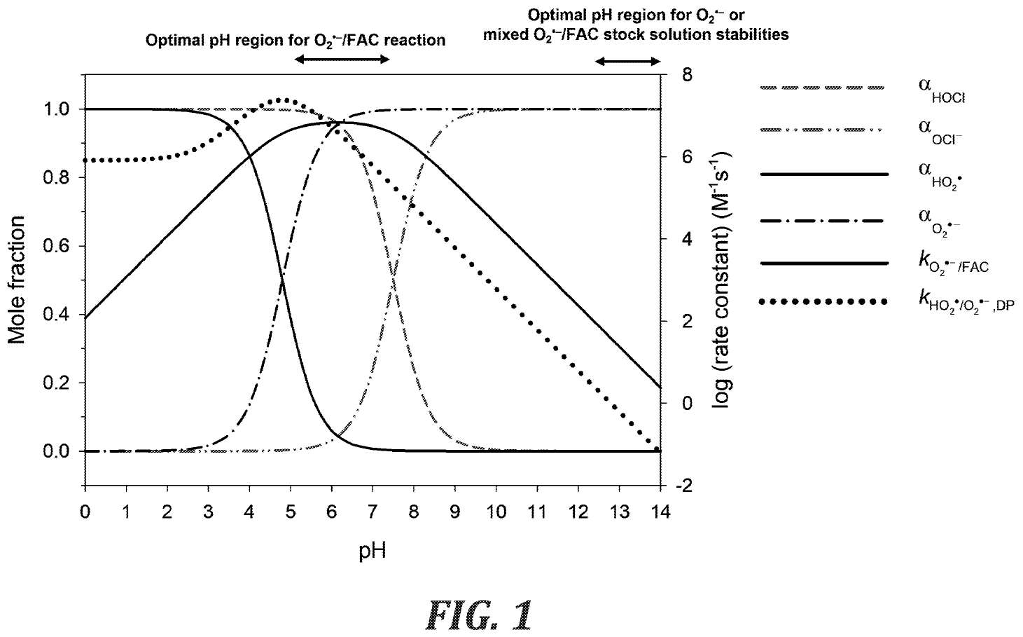

As indicated by Eq. 1, the reaction takes place between HOCl and O₂^{⋅-}, while the side reactions of HO₂^{⋅} with HOCl and OCl⁻, and of O₂^{⋅-} with OCl⁻, are negligible in comparison to Eq. 1. The apparent kinetics for the reaction of HO₂^{⋅}/O₂^{⋅-} (comprising the sum of O₂^{⋅-} and its conjugate acid, hydroperoxyl, HO₂^{⋅}) with O₂^{⋅-}/FAC therefore depend strongly on pH. This pH dependence can be described by Eq. 2:

$${k}_{app , {O}_{2}^{\cdot \_} / FAC} = {k}_{1} {α}_{{O}_{2}^{\cdot \_}} {α}_{HOCl} = {k}_{1} ( \frac{{K}_{a , {HO}_{2}^{\cdot }}}{[ {H}^{+} ] + {K}_{a , {HO}_{2}^{\cdot }}} ) ( \frac{[ {H}^{+} ]}{[ {H}^{+} ] + {K}_{a , HOCl}} ) \qquad Equation ( 2 )$$

where k_{app,O}_{₂}_{^{⋅−}}_{/FAC} represents the pH-dependent apparent second-order rate constant for the O₂^{⋅-}/FAC reaction at 25° C., and K_{a,HO2⋅}=10^{-4.8} and K_{a,HOCl}=10^{-7.5} represent the acid-base dissociation constants for the equilibria HO₂^{⋅}⇄H⁺+O₂^{⋅-} and HOCl⇄H⁺+OCl⁻, respectively. As shown in FIG. 1, the theoretical k_{app,O}_{₂}_{^{⋅−}}_{/FAC} increases from 2.4 M⁻¹s⁻¹ at pH 14 to a maximum of 6.9×10⁶ M⁻¹s⁻¹ at pH 6.2, with rate constants in excess of 10⁶ M⁻¹s⁻¹ at pH 6-8.

In addition to HO^{⋅}, the O₂^{⋅-}/FAC reaction leads to the formation of various reactive chlorine species (RCS), including chlorine monoxide radical (ClO^{⋅}), hydroxidochlorate radical (HOCl^{⋅-}), chlorine radical (Cl^{⋅}), and dichloride radical (Cl₂^{⋅-}) (Eqs. 3-9).

| | | |
|---|---|---|
| HOCl + HO^{•} → ClO^{•} + H₂O | k₃ = 1.2 × 10⁹ M⁻¹s⁻¹ | Equation |
| | | (3) |
| OCl⁻ + HO^{•} → ClO^{•} + OH⁻ | k₄ = 6.4 × 10⁹ M⁻¹s⁻¹ | Equation |
| | | (4) |
| HO^{•} + Cl⁻ ↔ HOCl^{•-} | k_{5f} = 4.3 × 10⁹ M⁻¹s⁻¹ | Equation |
| | | (5) |
| | k₅ᵣ = 6.1 × 10⁹ s⁻¹ | |
| HOCl^{•-} + H⁺ ↔ Cl^{•} + H₂O | k_{6f} = 2.1 × 10¹⁰ M⁻¹s⁻¹ | Equation |
| | | (6) |
| | k₆ᵣ = 4.5 × 10³ M⁻¹s⁻¹ | |
| Cl^{•} + HOCl → H⁺ + Cl⁻ + ClO^{•} | k₇ = 3.0 × 10⁹ M⁻¹s⁻¹ | Equation |
| | | (7) |
| Cl^{•} + ClO⁻ → Cl⁻ + ClO^{•} | k₈ = 8.2 × 10⁹ M⁻¹s⁻¹ | Equation |
| | | (8) |
| Cl^{•} + Cl⁻ ↔ Cl₂^{•-} | k_{9f} = 6.5 × 10⁹ M⁻¹s⁻¹ | Equation |
| | | (9) |
| | k₉ᵣ = 1.1 × 10⁵ s⁻¹ | |

RCS can also contribute substantially to degradation of organic contaminants, especially those containing electron-rich functional groups.

While the O₂^{⋅-}/FAC reaction has long been recognized as a potential source of HO^{⋅} in biological systems, and has recently been identified as a driver of radical pathways in the oxidation of phenols and hydroquinones by FAC, and in a newly-reported approach to photocatalytic FAC activation, it has otherwise received relatively little attention as a possible basis for an AOP. This is perhaps mainly due to the instability of O₂^{⋅-} and HO₂^{⋅} under circumneutral pH conditions, on account of their rapid disproportionation to H₂O₂ and its conjugate base hydroperoxide (HO₂⁻) in aqueous solution (Eqs. 10-12):

| HO₂^{•} + HO₂^{•} → H₂O₂ + O₂ | k₁₀ = 8.3 × 10⁵ M⁻¹s⁻¹ | Equation |
|---|---|---|
| | | (10) |
| HO₂^{•} + O₂^{•-} → HO₂⁻ + O₂ | k₁₁ = 9.7 × 10⁷ M⁻¹s⁻¹ | Equation |
| | | (11) |
| O₂^{•-} + O₂^{•-} → O₂²⁻ + O₂ | k₁₂ < 3.5 × 10⁻¹ M⁻¹s⁻¹ | Equation |
| | | (12) |

As evident from Eqs. 10-12, the apparent kinetics of HO₂^{⋅}/O₂^{⋅-} disproportionation depend strongly on pH, where this pH dependence can be described by Eq. 13:

$${k}_{app , {HO}_{2}^{\cdot \_} / {O}_{2}^{\cdot \_} , DP} = {{k}_{10} ( {α}_{{HO}_{2}^{\cdot }} )}^{2} + {K}_{11} {α}_{{HO}_{2}^{\cdot }} {α}_{{O}_{2}^{\cdot \_}} = {{k}_{10} ( \frac{[ {H}^{+} ]}{[ {H}^{+} ] + {K}_{a , {HO}_{2}^{\cdot }}} )}^{2} + {k}_{11} ( \frac{[ {H}^{+} ]}{[ {H}^{+} ] + {K}_{a , {HO}_{2}^{\cdot }}} ) ( \frac{{K}_{a , {HO}_{2}^{\cdot }}}{[ {H}^{+} ] + {K}_{a , {HO}_{2}^{\cdot }}} ) \qquad Equation ( 13 )$$

with k_{app,HO}_{₂}_{^{⋅}}_{/O}_{₂}_{^{⋅−}}_{,DP} representing the pH-dependent apparent second-order rate constant for the overall disproportionation reaction. The disproportionation of O₂^{⋅-} and HO₂^{⋅}, as shown in Eqs. 10-11, lead to extremely rapid decay of HO₂^{⋅}/O₂^{⋅-} at circumneutral pH, as shown in FIG. 1. However, as shown in FIG. 1, and as apparent from Eqs. 12-13, stability of HO₂^{⋅}/O₂^{⋅-} increases significantly with increasing pH. Therefore, aqueous O₂^{⋅-} stock solutions with lifetimes of several minutes or longer can be prepared at pH 12 or greater, and then dosed to FAC-containing waters at lower pH, thus providing opportunities for their use in contaminant oxidation, consistent with Eq. 1. The low value of k_{app,O}_{₂}_{^{⋅−}}_{/FAC} at pH>12 (FIG. 1) provides the added possibility of premixing alkaline O₂^{⋅-}/FAC solutions that can then be “activated” by dosing to lower-pH waters, effectively providing stock solutions of HO^{⋅} and RCS.

Many previously-utilized O₂^{⋅-} preparation methods require specialized equipment and/or organic solvents or additives that would hinder use of the resulting stock solutions in an AOP. However, here certain photochemical approaches and KO₂ dissolution can yield high-μM to mM O₂^{⋅-} concentrations in fully aqueous solution at pH≥11 without such equipment, solvents, or additives. With the use of O₂^{⋅-} stocks at such high concentrations, the O₂^{⋅-}/FAC reaction as herein described provides a convenient and widely-accessible HO^{⋅} source, especially considering the already widespread use of FAC in water and wastewater treatment.

### Example 3

### Preparation of O₂^{⋅-} Stock Solutions

### (i) KO₂ Dissolution in NaOH Solution

KO₂ dissolution in 0.1M and 1M NaOH (NaOH solutions added to KO₂ solids). Desired masses of KO₂ were weighed and placed in 20 mL amber borosilicate glass vials, NaOH solution (0.1M or 1 M) was rapidly poured into the vials, and the vials were shaken immediately after NaOH addition to ensure full dissolution of KO₂ solids. The pH values of 0.1M and 1M NaOH solutions were 13.0 and 13.9, respectively, at room temperature (22±2° C.), as confirmed by direct measurement for 0.1M NaOH, and calculated using Visual MINTEQ with correction for ionic strength/activity via the Brønsted-Guggenheim-Scatchard implementation of specific ion interaction theory for 1M NaOH. (Direct pH measurement at 1M NaOH concentration proved problematic due to apparent elevated sensitivity of the electrode to sodium error at >0.1M NaOH).

KO₂ was dissolved in NaOH solutions prepared in Milli-Q water at initial concentrations ranging from 0.5 to 10 mM, yielding HO₂^{⋅}/O₂^{⋅-} concentrations ranging from ˜0.07-2.1 mM (as well as H₂O₂/HO₂⁻ at similar levels) in the resulting stock solutions. As expected, higher initial KO₂ concentrations led to higher initial [HO₂^{⋅}/O₂^{⋅-}]₀ in stock solutions. However, [HO₂^{⋅}/O₂^{⋅-}]₀ was always markedly lower than the concentrations of KO₂ dissolved, with yields ˜20%. This may have been due to the presence of very high localized concentrations of HO₂^{⋅}/O₂^{⋅-}, with concomitant rapid disproportionation to H₂O₂/HO₂⁻, as illustrated in Eqs. 10-11, and/or direct reactions with H₂O₂/HO₂⁻, as illustrated in Eqs. 14-16, during dissolution of the KO₂ solids, even with rapid mixing.

| HO₂^{•} + H₂O₂ → HO^{•} + H₂O + O₂ | k_{S1} = 10⁻² to 5 M⁻¹s⁻¹ | Equation |
|---|---|---|
| | | (14) |
| O₂^{•-} + H₂O₂ → HO^{•} + OH⁻ + O₂ | k_{S2} = 10⁻⁴ to 2.3 M⁻¹s⁻¹ | Equation |
| | | (15) |
| O₂^{•-} + HO₂⁻ → O₂ + H₂O₂ | k_{S3} < 2 M⁻¹s⁻¹ | Equation |
| | | (16) |

KO₂ dissolution in 0.05M NaOH (K02 solids added to NaOH solutions). 10 mL of 0.05 M NaOH (pH 12.7) at room temperature (22±2° C.) was placed in a 20 mL amber borosilicate glass vial, and stirred by a magnetic stirrer at high enough mixing speed to generate a visible vortex in the liquid. Desired masses of KO₂ were weighed and immediately added into the vial. This approach of adding KO₂ solids to vigorously mixed NaOH solutions appears to more effectively decrease localized concentrations of HO₂^{⋅}/O₂^{⋅-} during preparation of O₂^{⋅-} stock solutions, compared to addition of NaOH solutions to KO₂ solids. This can in turn improve O₂^{⋅-} yields and stability. An initial KO₂ concentration of 20 mM was selected for use in preparing O₂^{⋅-} stocks for O₂^{⋅-}/FAC treatment with the foregoing approach.
(ii) UV irradiation of alkaline H₂O₂/HO₂⁻

The photolysis of H₂O₂ (pKₐ=11.6) and its conjugate base, hydroperoxide (HO₂⁻), proceeds via Eqs. 17-18,

H₂O₂ [symbol] HO^{⋅}+HO^{⋅} Equation (17)

HO₂⁻ [symbol] HO^{⋅}+O^{⋅-} Equation (18)

where in the presence of excess H₂o₂/HO₂⁻ (comprising the sum of H₂O₂ and HO₂⁻), subsequent reactions of HO^{⋅} and its conjugate base, oxide radical (O^{⋅-}) (pKₐ=11.9), with H₂O₂/HO₂⁻ can lead to formation of O₂^{⋅-} (Eqs. 19-22).

| HO^{•} + H₂O₂ → H₂O + O₂^{•-} + H⁺ | k_{S6} = 2.7 × 10⁷ M⁻¹s⁻¹ | Equation |
|---|---|---|
| | | (19) |
| O^{•-} + H₂O₂ → OH⁻ + O₂^{•-} + H⁺ | k_{S7} ≤ 5 × 10⁸ M⁻¹s⁻¹ | Equation |
| | | (20) |
| HO^{•} + HO₂⁻ → H₂O + O₂^{•-} | k_{S8} = 7.5 × 10⁹ M⁻¹s⁻¹ | Equation |
| | | (21) |
| O^{•-} + HO₂⁻ → OH⁻ + O₂^{•-} | k_{S9} = 4 × 10⁸ M⁻¹s⁻¹ | Equation |
| | | (22) |

Under circumneutral pH conditions, rapid disproportionation of HO₂^{⋅} and O₂^{⋅-} (Eqs. 10-11) prevents their buildup in solution. However, under strongly alkaline conditions (pH>12), O₂^{⋅-} can accumulate. Consistent with this, O₂^{⋅-} has been reported as a product in the photolysis of HO₂⁻ (Allen and Bielski, 1980; Behar and Czapski, 1970; Bielski and Cabelli, 1995; Lunak and Sedlak, 1992). In this work, O₂^{⋅-} was in turn generated by using a 5W low-pressure (LP) Hg lamp (Pen-Ray 11SC-1, UVP) equipped with an 18 mA AC power supply (Pen-Ray 11SC-1, UVP) to irradiate alkaline solutions of H₂O₂/HO₂⁻. The Hg lamp, which emits monochromatic ultraviolet (UV) light (λ=254 nm), was housed in a metal shield with a rectangular opening of 0.48 cm×3.81 cm. Irradiations were initiated by placing a 1-cm quartz cuvette containing 0.05M or 0.0316M NaOH, and additionally various initial concentrations of H₂O₂/HO₂⁻ in the path of the emitted light. The cuvette was placed ˜4 mm away from the outer surface of the lamp for irradiations, with the contents continuously stirred by a magnetic stir bar at 200 rpm.

Irradiation at initial concentrations of H₂O₂/HO₂⁻ ranging from 5-20 mM resulted in the buildup of HO₂^{⋅}/O₂^{⋅-} over 3-5 minutes to maximal HO₂^{⋅}/O₂^{⋅-} concentrations of ˜1 mM and ˜0.5 mM in 0.05M NaOH (pH 12.7) and 0.0316M NaOH (pH 12.5) solutions, respectively, with higher [H₂O₂/HO₂⁻]₀ yielding higher [HO₂^{⋅}/O₂^{⋅-}]. These concentrations exceed the highest O₂^{⋅-} concentrations (˜400 μM) previously reported when using vacuum-UV photolysis of oxygenated aqueous ethanol and/or formate solutions, or UV photolysis of a mixture of ketones with alcohols.
(iii) O₃ treatment of alkaline H₂O₂/HO₂⁻

Under conditions of excess H₂O₂/HO₂⁻ at alkaline pH, O₃ is rapidly consumed by HO₂⁻ to yield O₂^{⋅-} and HO^{⋅} by way of a multi-step reaction now understood to proceed through adduct HO₅⁻ (Eq. 23), with scavenging of HO^{⋅} by H₂O₂/HO₂⁻, leading to further O₂^{⋅-} (Eqs. 19-22). In this process, rapid reaction of O₃ with O₂^{⋅-} to yield O₃^{⋅-} (and subsequently, O^{⋅-}, which in equilibrium with HO^{⋅}, will in turn be scavenged by H₂O₂/HO₂⁻ as shown in Eqs. 19-22) will to some extent self-limit O₂^{⋅-} accumulation (Eqs. 24-25).

| O₃ + HO₂⁻ →→ O₂^{•-} + HO^{•} + | k_{S10} = 2.8 × 10⁶ M⁻¹s⁻¹ | Equation |
|---|---|---|
| O₂ | | (23) |
| O₃ + O₂^{•-} → O₂ + O₃^{•-} | k_{S11} = 1.6 × 10⁹ M⁻¹s⁻¹ | Equation |
| | | (24) |
| O₃^{•-} → O^{•-} + O₂ | k_{S12} = 2.8 × 10³ s⁻¹ | Equation |
| | | (25) |

In this work, aqueous O₃ stock solutions were prepared by bubbling gas-phase O₃ produced by a high-output, air-cooled, corona-discharge ozone generator (IN USA) through an ice-chilled Erlenmeyer flask of Milli-Q water until stable concentrations were reached (typically after 1 hr). O₃ concentrations obtained in the stock solutions typically reached ˜1.1-1.2 mM, and were measured spectrophotometrically at 260 nm (ϵ=3150 M⁻¹ cm⁻¹). Four mL volumes of O₃ stock solution were transferred by gas-tight glass syringe (either manually or with a syringe pump) into amber borosilicate glass vessels containing 4 mL of 1M NaOH amended with [H₂O₂/HO₂⁻]₀=1.2 mM under constant stirring.

O₃ treatment of alkaline H₂O₂/HO₂⁻ under in situ conditions of pH ˜13.6, [H₂O₂/HO₂⁻]₀=0.6 mM, and [O₃]₀=0.575 mM, resulted in the buildup of HO₂^{⋅}/O₂^{⋅-} over 30 s to maximal concentrations ranging from 0.02-0.06 mM. Higher HO₂^{⋅}/O₂^{⋅-} levels were observed when using a syringe pump to slowly meter the rate of O₃ addition to alkaline H₂O₂/HO₂⁻ solutions instead of dosing rapidly by manual injection. This effect was likely due to a lowering of O₃ concentrations present in solution at a given instant, with consequent minimization of the consumption of O₂^{⋅-} generated, as shown in Eq. 23, by subsequent reaction with O₃ (Eq. 24). Given that the HO₂^{⋅}/O₂^{⋅-} concentrations generated by this approach were low (<70 μM), the subsequent O₂^{⋅-}/FAC treatments were performed by using O₂^{⋅-} stocks generated via the other two methods mentioned above.

### Example 4

### Confirmation of Radical Formation from the O₂^{⋅-}/FAC Reaction

### (i) Probe Compound Degradation

pH 7, 50 mM phosphate buffer solutions containing 1 μM nitrobenzene (NB), benzoic acid (BA), 1,4-dimethoxybenzene (DMB), and/or para-chlorobenzoic acid (pCBA) were subjected to single-dose postmix O₂^{⋅-}/FAC treatment with increasing [HO₂^{⋅}/O₂^{⋅-}]₀ (20, 50, 100, 200 μM) and [FAC]₀ (10, 25, 50, 100 μM) at a fixed 2:1 molar [HO₂^{⋅}/O₂^{⋅-}]₀/[FAC]₀ ratio. NB reacts rapidly only with HO^{⋅} (of the radicals relevant to the O₂^{⋅-}/FAC reaction), while BA reacts rapidly with HO^{⋅} and Cl′, and DMB reacts rapidly with HO^{⋅}, Cl^{⋅}, ClO^{⋅}, and likely also Cl₂^{⋅-}. HO^{⋅} exposures were measured based on NB degradation during treatment, and RCS exposures estimated based on degradation of BA and DMB. pCBA, which reacts rapidly with HO^{⋅} and presumably also Cl^{⋅}, considering its structural similarity to BA, was used as a non-specific radical probe in some preliminary experiments.

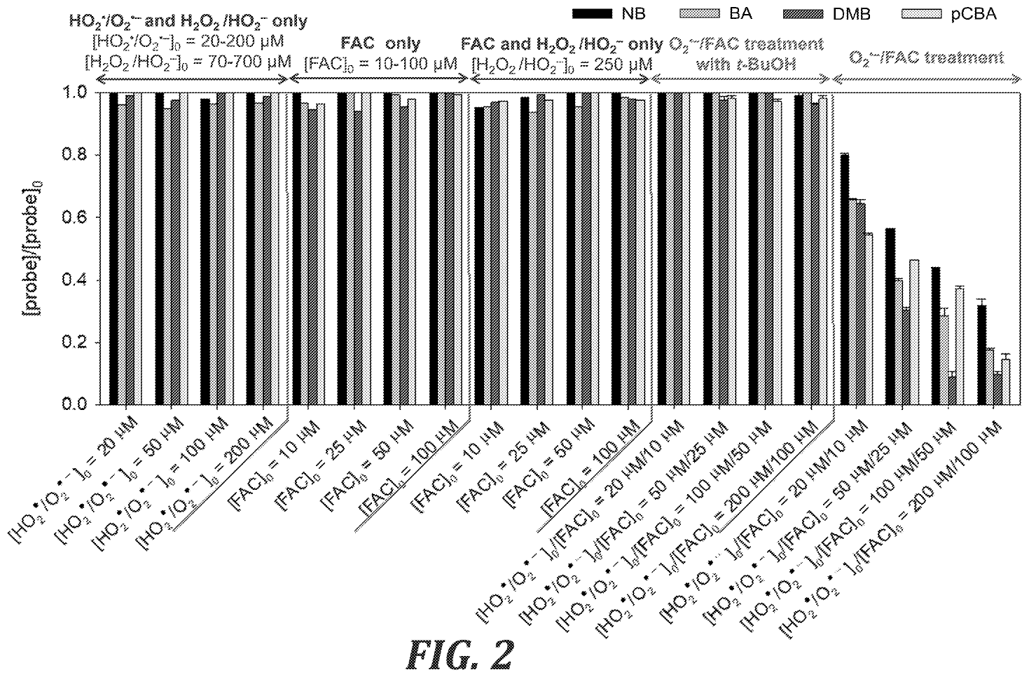

As shown in FIG. 2, increasing probe losses were observed when jointly increasing [HO₂^{⋅}/O₂^{⋅-}]₀ and [FAC]₀. In contrast, none of the probes were degraded in solutions treated separately with HO₂^{⋅}/O₂^{⋅-} or FAC, confirming that probe degradation was not due to direct reactions with HO₂^{⋅}/O₂^{⋅-} or FAC. Direct reactions with H₂O₂/HO₂⁻ could also be ruled out on the basis of the treatments with HO₂^{⋅}/O₂^{⋅-} in the absence of FAC, as O₂^{⋅-} stocks also contained H₂o₂/HO₂⁻ at levels yielding [H₂O₂/HO₂⁻]₀=70-700 μM in the receiving solutions (FIG. 2). Furthermore, no probe losses were observed in the presence of FAC dosed with [H₂O₂/HO₂⁻]₀=250 μM (FIG. 2), confirming probe degradation during O₂^{⋅-}/FAC treatment was not due to singlet oxygen (¹O₂) generated from reaction of FAC with H₂O₂/HO₂⁻. Finally, no probe losses were observed during postmix O₂^{⋅-}/FAC treatment in the presence of 50 mM t-BuOH. This was sufficient to yield ≥93% scavenging of HO^{⋅} and, as a consequence, block the formation of RCS, since in this system, RCS are secondary radicals generated from HO^{⋅} via Eqs. 3-9, which would have been precluded due to scavenging of HO^{⋅} by t-BuOH (FIG. 2). Thus, probe degradation during O₂^{⋅-}/FAC treatment could be attributed to HO^{⋅} and/or RCS.

Degradation of the HO^{⋅}-selective probe NB during O₂^{⋅-}/FAC treatment, in conjunction with the lack of NB or other probe degradation during O₂^{⋅-}/FAC treatment in the presence of t-BuOH, point to HO^{⋅} as a driver of probe degradation under the conditions evaluated, consistent with Eq. 1. However, trends in NB, BA, and DMB degradation indicate that RCS also play a role (as discussed later in Example 5), consistent with Eqs. 3-9.

(ii) Hydroxy-Terephthalate (hTPA) Formation from Terephthalate (TPA)

TPA is well known to yield hTPA upon reaction with HO^{⋅}, which can be detected by a fluorometer. When dosed with increasing [HO₂^{⋅}/O₂^{⋅-}]₀ during single-dose postmix treatment, solutions containing [TPA]₀=10 μM and [FAC]₀=100 μM at pH 7 yielded increasing hTPA levels. In contrast, hTPA formation was not observed in such solutions without HO₂^{⋅}/O₂^{⋅-} addition, or in FAC-free controls treated with [HO₂^{⋅}/O₂^{⋅-}]₀=25 μM (also including [H₂O₂/HO₂⁻]₀=200 μM). These observations further highlight the role of HO^{⋅} as an oxidant during O₂^{⋅-}/FAC treatment.

(iii) Formaldehyde Generation from t-BuOH

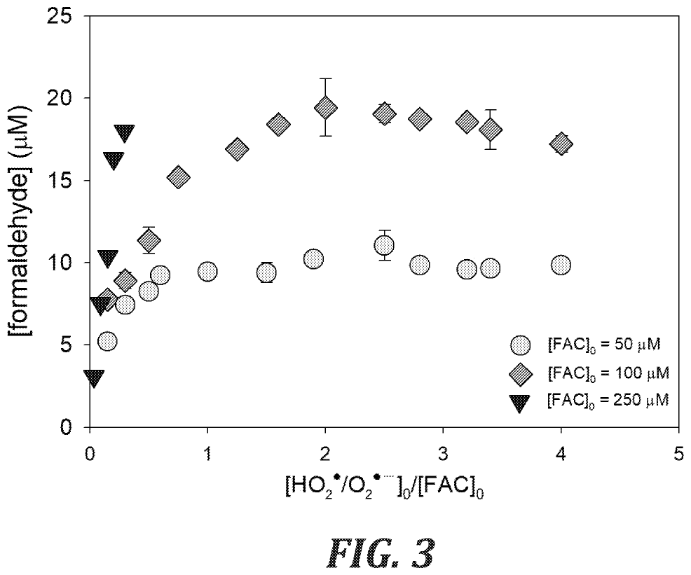

The reaction of t-BuOH with HO^{⋅} to yield formaldehyde can be used as a means of quantifying HO^{⋅} yields in various oxidation processes. When dosed with increasing [HO₂^{⋅}/O₂^{⋅-}]₀ during single-dose postmix treatment, solutions containing [t-BuOH]₀=50 mM and [FAC]₀=50, 100, or 250 μM at pH 7 yielded increasing formaldehyde levels at [HO₂^{⋅}/O₂^{⋅-}]₀/[FAC]₀ below 1, with formaldehyde levels plateauing as [HO₂^{⋅}/O₂^{⋅-}]₀/[FAC]₀ exceeded 1 (FIG. 3). This likely reflects increasing conversion of [FAC]₀ to HO^{⋅} at sub-stoichiometric [HO₂^{⋅}/O₂^{⋅-}]₀, with full conversion of [FAC]₀ (and maximum HO^{⋅} yield) reached at stoichiometric or higher concentrations of [HO₂^{⋅}/O₂⁻]₀ (i.e., at [HO₂^{⋅}/O₂^{⋅-}]₀/[FAC]₀≥1). Contributions of RCS to formaldehyde formation can be neglected, as HO^{⋅} is the precursor of the RCS, and its scavenging by t-BuOH would have precluded RCS formation as shown in Eqs. 3-9.

In the experiments shown in FIG. 3, [t-BuOH]₀=50 mM would have been sufficient to scavenge ≥90% of HO^{⋅}, except at the highest [HO₂^{⋅}/O₂^{⋅-}]₀ applied (at which f(HO^{⋅}), the fraction of total generated HO^{⋅} scavenged by t-BuOH, would have been equal to 0.88) (FIG. 3). Based on a reported molar yield of ˜25% for formaldehyde formation from reaction of HO^{⋅} with t-BuOH, and an apparent plateau value of ˜0.2 mol formaldehyde formed/mol FAC consumed, as shown in FIG. 3, an estimated yield of ˜0.8 mol HO^{⋅} formed/mol FAC consumed was obtained for the O₂^{⋅-}/FAC reaction under the conditions applied. This is lower than the theoretical yield of 1 mol HO^{⋅}/mol FAC (Eq. 1), and may represent an underestimate due to: (a) uncertainties in formaldehyde yield from t-BuOH in the presence of oxidants other than HO^{⋅}; and/or (b) inhibition of formaldehyde formation by reaction of excess HO₂^{⋅}/O₂^{⋅-} with the primary peroxyl radical formed in reaction of HO^{⋅} with t-BuOH.

### Example 5

### Application of O₂^{⋅-}/FAC Treatment

### (i) Effects of pH

Little variation in pCBA degradation was observed during O₂^{⋅-}/FAC treatment at pH 7, 8, 9, and 10. The small apparent decrease in pCBA degradation at pH>7 may have been attributable to (a) an increase in k_{app,HO}_{₂}_{^{⋅}}_{/O}_{₂}_{^{⋅−}}_{,DP} relative to k_{app,O}_{₂}_{^{⋅}}_{/FAC}, leading to increased loss of HO₂^{⋅}/O₂^{⋅-} via disproportionation (Eqs. 10-11), and/or (b) a shift in speciation from HOCl to OCl⁻ (pKₐ=7.5), leading to increased scavenging of HO^{⋅} by the latter (Eqs. 3-4). Although subsequent discussion focuses on O₂^{⋅-}/FAC treatment at pH 7, these findings indicate comparable effectiveness could be achievable at other pH values.

(ii) Effects of [HO₂^{⋅}/O₂^{⋅-}]₀/[FAC]₀ and absolute values of [HO₂^{⋅}/O₂^{⋅-}]₀ and [FAC]₀

Due to (a) the dependence of HO^{⋅} yield on [HO₂^{⋅}/O₂^{⋅-}]₀ and [FAC]₀, and (b) the rapid reactions of HO^{⋅} with FAC and HO₂^{⋅}/O₂^{⋅-} (Eqs. 3-4 and 26-27, respectively),

HO^{⋅}+HO₂^{⋅}→H₂O+O₂k₁₄=7.1×10⁹M⁻¹s⁻¹ Equation (26)

HO^{⋅}+O₂^{⋅-}→OH⁻+O₂k₁₅=1.0×10¹⁰M⁻¹s⁻¹ Equation (27)

both relative and absolute concentrations of [HO₂^{⋅}/O₂^{⋅-}]₀ and [FAC]₀ may influence probe degradation and radical exposures, ∫₀^{t}[radical]dt, during O₂^{⋅-}/FAC treatment. NB, BA, DMB, and pCBA degradation were in turn evaluated over a range of [HO₂^{⋅}/O₂^{⋅-}]₀ and [FAC]₀ at [HO₂^{⋅}/O₂^{⋅-}]₀/[FAC]₀ ranging from 0.2-7.5, to evaluate resulting variations in ∫₀^{t}[radical]dt and identify optimal O₂^{⋅-}/FAC treatment conditions.

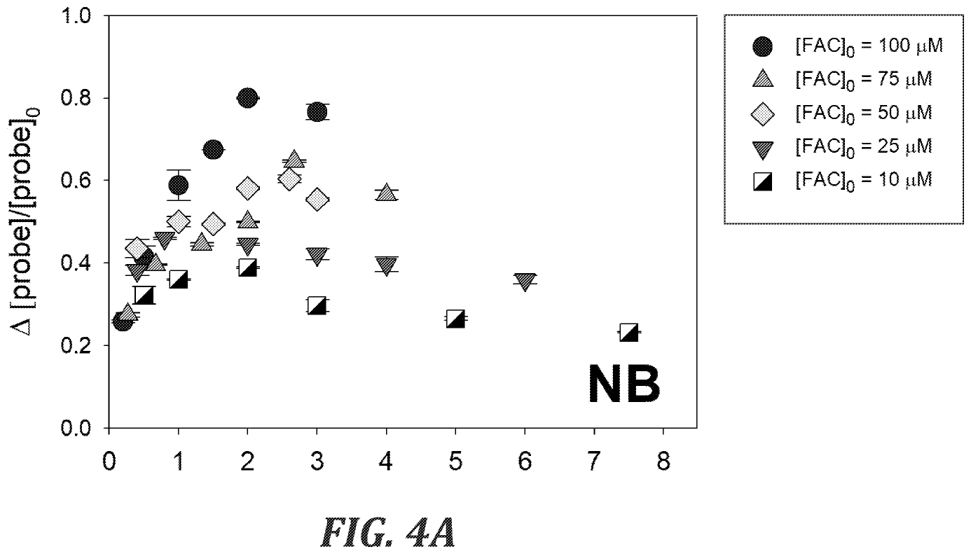

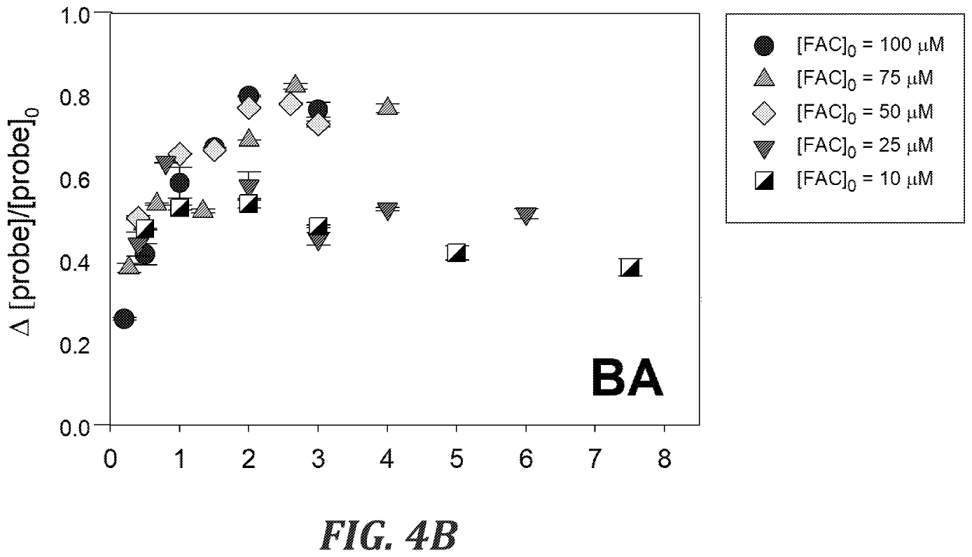

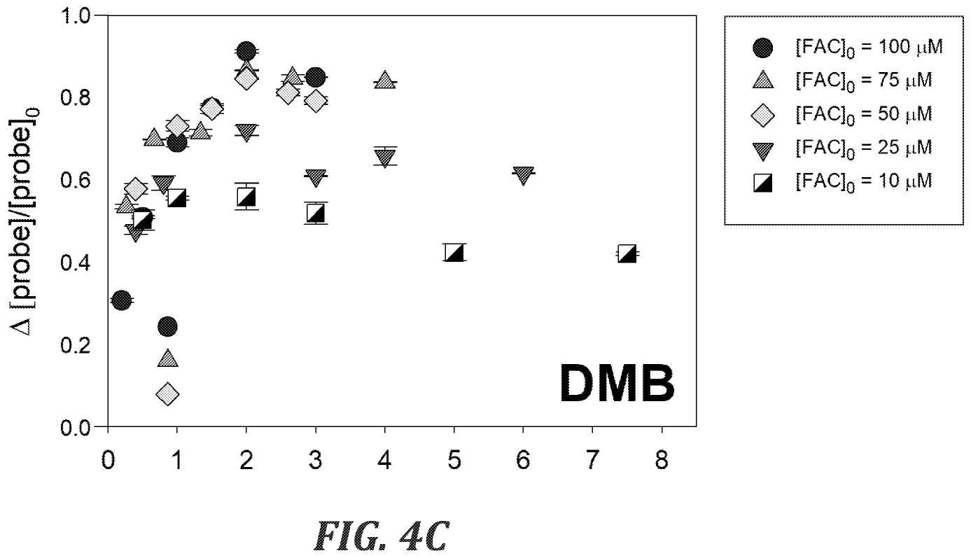

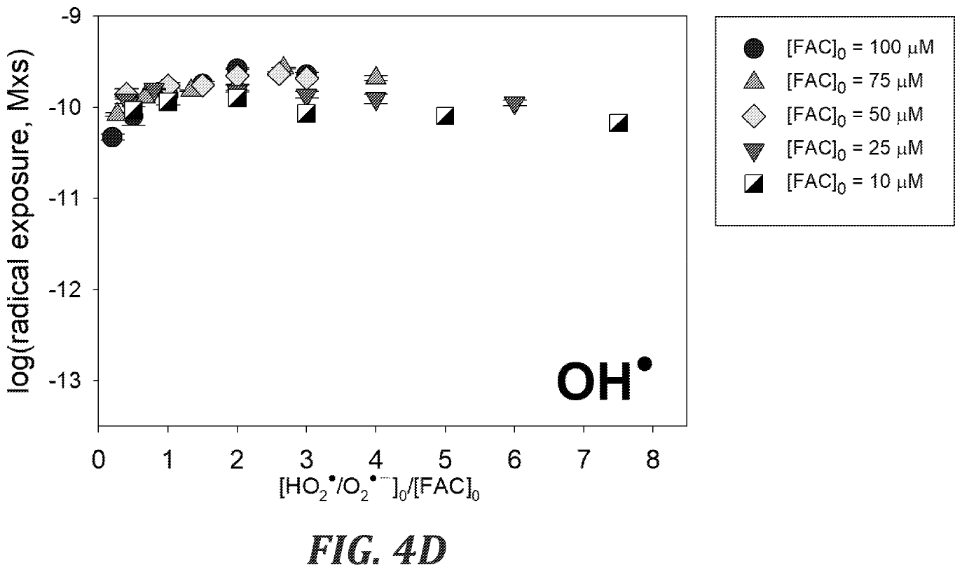

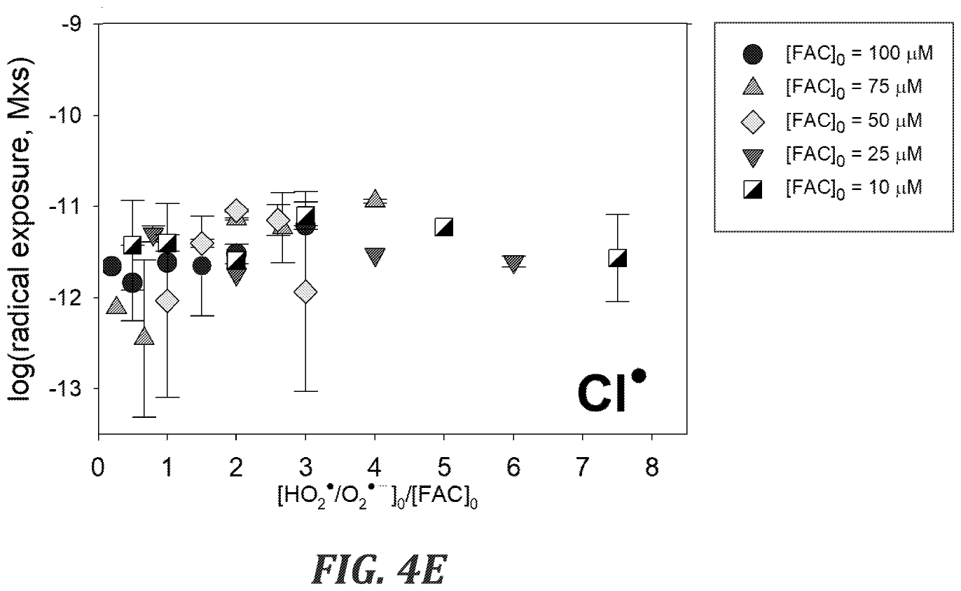

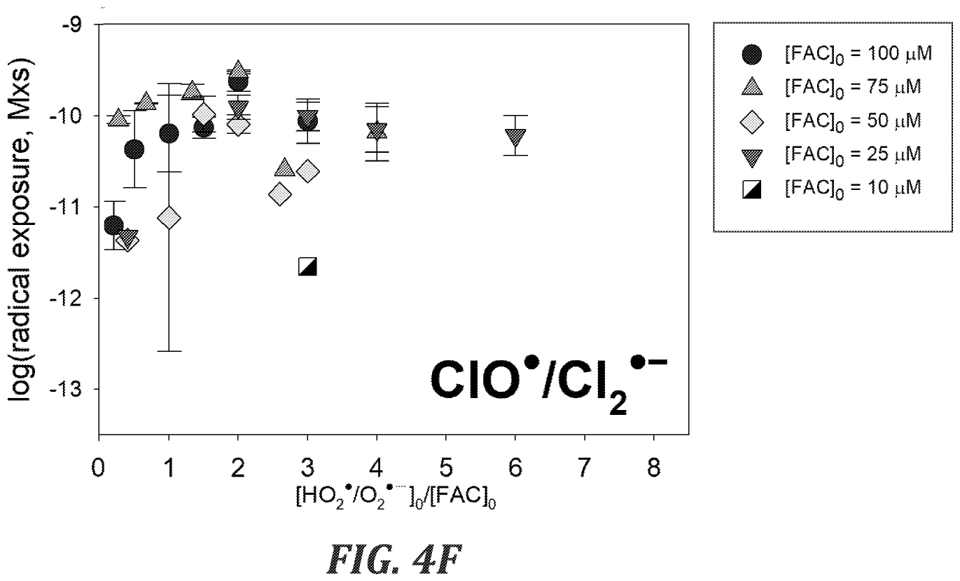

FIGS. 4A-4F, for single-dose postmix experiments, show the extents of NB, BA, DMB, and pCBA degradation, expressed as change in probe compound concentration normalized to initial probe compound concentration, or Δ[probe]/[probe]o (where probe=NB, BA, DMB, or pCBA), which increased with increasing [HO₂^{⋅}/O₂^{⋅-}]₀/[FAC]₀ up to maxima at [HO₂^{⋅}/O₂^{⋅-}]₀[FAC]₀˜2, beyond which Δ[probe]/[probe]₀ decreased with increasing [HO₂^{⋅}/O₂^{⋅-}]₀[FAC]₀. Furthermore, when holding [HO₂^{⋅}/O₂^{⋅-}]₀/[FAC]₀ fixed at 2, Δ[probe]/[probe]₀ generally increased as [HO₂^{⋅}/O₂^{⋅-}]₀ and [FAC]₀ were increased in tandem up to ˜200 μM and 100 μM, respectively, beyond which further increases in [HO₂^{⋅}/O₂^{⋅-}]₀ and [FAC]₀ appeared to yield diminishing improvement (FIGS. 4A-4F). The observed maximal levels of Δ[probe]/[probe]o for single-dosing of [HO₂^{⋅}/O₂^{⋅-}]₀=200 μM and [FAC]₀=100 μM translated to calculated exposures of ˜2-3×10⁻¹⁰ M×s for both ∫₀^{t}[HO^{⋅}]dt and ∫₀^{t}[ClO^{⋅}/Cl₂^{⋅}]dt , and ˜10⁻¹¹ M×s for ∫₀^{t}[Cl^{⋅}]dt , though with wider ranges apparent for ClO^{⋅}/Cl₂^{⋅-} and Cl^{⋅}, due in part to greater uncertainties in the small changes in probe concentrations from which these latter exposures were determined. Furthermore, it is worth noting that the values of ∫₀^{t}[radical]dt determined here do not account for uncertainties associated with the rate constants used in their determination, as the lack of reported error bounds for most of the associated rate constants precludes quantification of such uncertainties. The values are thus most appropriately interpreted as estimates, rather than exact values of ∫₀^{t}[radical]dt.

Similar to HO^{⋅} yields, HO^{⋅} exposures (and Δ[probe]/[probe]₀) increased with increasing [HO₂^{⋅}/O₂^{⋅-}]₀/[FAC]₀ up to a maximum. However, maximal HO^{⋅} exposures and Δ[probe]/[probe]₀ were observed at [HO₂^{⋅}/O₂^{⋅-}]₀/[FAC]₀˜2, rather than at [HO₂^{⋅}/O₂^{⋅-}]₀/[FAC]₀˜1 as for HO^{⋅} yields. This likely reflects a combination of increasing FAC conversion to HO^{⋅} via Eq. 1 as [HO₂^{⋅}/O₂^{⋅-}]₀ is increased, coupled with consumption of HO₂^{⋅}/O₂^{⋅-} by HO^{⋅} (Eqs. 26-27). Without the presence of 50 mM t-BuOH to block the reactions in Eqs. 26-27 (as in the HO^{⋅} yield measurements), they would divert available HO₂^{⋅}/O₂^{⋅-} away, as shown in Eq. 1, raising the [HO₂^{⋅}/O₂^{⋅-}]₀/[FAC]₀ ratio required for full conversion of FAC by HO₂^{⋅}/O₂^{⋅}. The observed decrease in HO^{⋅} exposures and Δ[probe]/[probe]₀ at [HO₂^{⋅}/O₂^{⋅-}]₀/[FAC]₀≥2 therefore likely reflects increasing scavenging of HO^{⋅} by excess HO₂^{⋅}/O₂^{⋅-} via the processes shown in Eqs. 26-27 as [HO₂^{⋅}/O₂^{⋅-}]₀/[FAC]₀ is further increased beyond the optimum ratio. The observed trends in ClO^{⋅}/Cl₂^{⋅-} Cl^{⋅} exposures vs [HO₂^{⋅}/O₂^{⋅-}]₀/[FAC]₀ (FIGS. 4E and 4F) can be similarly explained, as each RCS ultimately originates from HO^{⋅}, as shown in Eqs. 3-9. Based on these findings, a ratio of [HO₂^{⋅}/O₂^{⋅-}]₀/[FAC]₀˜2 was selected for use in most subsequent experiments.

In addition to the HO^{⋅} and RCS exposure optimum at [HO₂^{⋅}/O₂^{⋅-}]₀/[FAC]₀˜2, and the general increase in HO^{⋅} exposure with increasing [HO₂^{⋅}/O₂^{⋅-}]₀ and [FAC]₀ at fixed [HO₂^{⋅}/O₂^{⋅-}]₀/[FAC]₀, it is noteworthy that ClO^{⋅}/Cl₂^{⋅-} exposures and their relative contributions to degradation of the ClO^{⋅}/Cl₂^{⋅-}-reactive probe DMB generally increased with increasing [FAC]₀ up to an apparent maximum at [FAC]₀˜75 μM (FIG. 4F). This is likely attributable to increasing formation of ClO^{⋅} and/or Cl₂^{⋅-} as shown in Eqs. 3-9 with increasing [FAC]₀ (and associated background [Cl⁻]₀ in FAC stocks) up to ˜75 μM, beyond which disproportionation of ClO^{⋅} and/or Cl₂^{⋅-} (Eqs. 28-29) may predominate.

ClO^{⋅}+ClO^{⋅} [symbol] ClO₂⁻+OCl⁻+2H³⁰k₁₆=2.5×10⁹M⁻¹s⁻¹ Equation (28)

Cl₂^{⋅-}+Cl₂^{⋅-}→Cl₂+2Cl⁻k₁₇=3.5×10⁹M⁻¹s⁻¹ Equation (29)

The increasing relevance of ClO^{⋅}/Cl₂^{⋅-} relative to HO^{⋅} at higher [FAC]₀, and potential formation of ClO₂⁻ (a regulated DBP) via Eq. 28, suggest that there may be benefit to implementing O₂^{⋅-}/FAC treatment at lower [FAC]₀ if possible (as discussed below in Section (iv)).

(iii) Postmix Versus Premix Dosing of O₂^{⋅-} and FAC

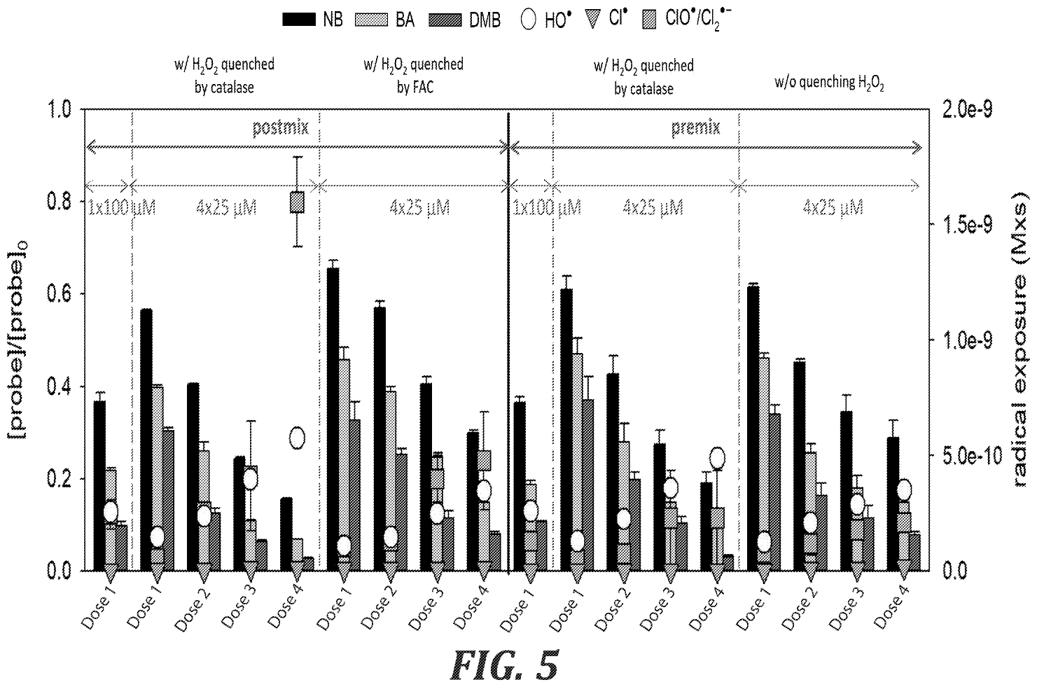

All results heretofore disclosed were obtained by adding alkaline O₂^{⋅-} stocks to buffered receiving solutions containing probes and FAC (postmix dosing). As noted above, it is also possible to prepare relatively stable (t_{1/2, O}_{₂}_{^{⋅−}}_{.FAC}>60 s) premixed O₂^{⋅-} and FAC stocks at pH>12. This can simplify O₂^{⋅-}/FAC treatment by enabling addition of premixed O₂^{⋅-}/FAC to receiving solutions as a single stock, with rapid conversion of the stock to HO^{⋅} and RCS at the lower pH of the receiving solution (premix dosing). This has the added benefit of preventing heterogeneities in [HO₂^{⋅}/O₂^{⋅-}]₀/[FAC]₀ that may result from non-ideal mixing of separate O₂^{⋅-} and FAC solutions during postmix dosing. A comparison of results for postmix and premix dosing at [HO₂^{⋅}/O₂^{⋅-}]₀/[FAC]₀=(200 μM)/(100 μM) is shown in FIG. 5 (see the two groups of measurements designated by the 1×100 μM labels). As apparent from FIG. 5, postmix and premix dosing yielded similar radical exposures and Δ[probe]/[probe]₀, confirming the utility of the premix dosing approach.

(iv) Single-Dose Versus Multiple-Dose O₂^{⋅-}/FAC Treatment

As noted in Section (ii) above, increased radical exposures and contaminant degradation may be achievable by implementing O₂^{⋅-}/FAC treatment at lower [FAC]₀ and [HO₂^{⋅}/O₂^{⋅-}]₀, due to consequent decreases in HO^{⋅} scavenging by FAC (Eqs. 3-4) and by H₂O₂/HO₂⁻ (Eqs. 19-22) associated with O₂^{⋅-} stocks. This may also lead to decreased HO⁻ scavenging by HO₂^{⋅}/O₂⁻ (Eqs. 26-27). One means of undertaking such an approach is to dose O₂^{⋅-} and FAC repeatedly (or continuously) at lower concentrations (multiple-dosing), rather than once at higher concentrations (single-dosing). To investigate this, Δ[probe]/[probe]₀ and radical exposures were measured when applying O₂^{⋅-} and FAC via several multiple-dose postmix treatment approaches: (a) twice at [HO₂^{⋅}/O₂^{⋅-}]₀/[FAC]₀=(100 μM)/(50 μM) (henceforth designated as 2×50 μM, with the 50 μM referring to applied [FAC]₀), (b) four times at [HO₂^{⋅}/O₂^{⋅-}]₀/[FAC]₀=(50 μM)/(25 μM) (i.e., 4×25 μM), and (c) ten times at [HO₂^{⋅}/O₂^{⋅-}]₀/[FAC]₀=(20 μM)/(10 μM) (i.e., 10×10 μM). Receiving solutions were treated with catalase after each O₂^{⋅-} dosing step to completely remove H₂O₂/HO₂⁻ derived from O₂^{⋅-} stocks, and FAC was then added into the receiving solutions for the subsequent step. Without H₂O₂/HO₂⁻ quenching beforehand, FAC added to the receiving solutions would have first been consumed via the direct reaction with H₂O₂/HO₂⁻. The removal of residual H₂O₂/HO₂⁻ between O₂^{⋅-} dosing steps was thus necessary to enable the use of postmix O₂^{⋅-} dosing, which requires the presence of FAC in receiving solutions prior to O₂^{⋅-} addition.

Measurements obtained from these multiple-dose postmix treatments were then compared to measurements obtained when applying O₂^{⋅-} and FAC via single-dose postmix treatment at [HO₂^{⋅}/O₂^{⋅-}]₉/[FAC]₀=(200 μM)/(100 μM) (i.e., 1×100 μM). In all four cases, the total (cumulative) levels of [HO₂^{⋅}/O₂^{⋅-}]_{0.tot} and [FAC]_{0.tot} applied summed to 200 μM and 100 μM, respectively.

As shown in FIG. 5, increased ∫₀^{t}[HO^{⋅}]dt and Δ[probe]/[probe]₀ were observed when applying lower [HO₂^{⋅}/O₂^{⋅-}]₀ and [FAC]₀ in multiple doses to achieve the same cumulative [HO₂^{⋅}/O₂^{⋅-}]_{0.tot} and [FAC]_{0.tot} levels as in a single dose. In general, higher ∫₀^{t}[HO^{⋅}]dt and Δ[probe]/[probe]₀ were observed at lower [HO₂^{⋅}/O₂^{⋅-}]₀ and [FAC]₀, with ∫₀^{t}[HO^{⋅}]dt and Δ[probe]/[probe]₀ for the single- and multiple-dosing approaches ranked in the order 10×10 μM-4×25 μM>2×50 μM>1×100 μM (data for 2×50 μM and 10×10 μM are not shown here). The effects of multiple-dosing on ∫₀^{t}[ClO^{⋅}/Cl₂^{⋅}]dt and ∫₀^{t}[Cl^{⋅}]dt were less clear, due to higher uncertainties associated with these values (FIG. 5).

It is worth noting that the use of catalase as a H₂O₂/HO₂⁻ quenching agent is not likely to be practical for water/wastewater treatment. As a more practical alternative, the removal of H₂O₂/HO₂⁻ can also be achieved simply by reaction with excess FAC. To investigate this, further multiple-dose postmix experiments were undertaken in which FAC was added to receiving solutions between O₂^{⋅-} dosing steps at concentration sufficient to consume all H₂O₂/HO₂⁻, while also leaving a desired level of FAC residual for subsequent reactions with O₂^{⋅-}. Analogous results were obtained when applying 4×25 μM multiple-dose postmix treatment with H₂O₂/HO₂⁻ quenched by FAC instead of catalase after each dosing step, though ∫₀^{t}[HO^{⋅}]dt and Δ[probe]/[probe]₀ levels were somewhat lower than when using catalase for H₂O₂/HO₂⁻ quenching (FIG. 5). This may reflect the presence of higher levels of background HO^{⋅} scavengers (e.g., Cl⁻; Eqs. 5-9) originating from FAC stocks, due to use of elevated FAC concentrations to quench H202/H02 (see below for discussion of maximal expected Cl⁻ concentrations following quenching of H₂O₂/HO₂⁻ with FAC). Experiments using pCBA as a probe and FAC to quench H₂O₂/HO₂⁻ yielded similar results.

Additional experiments were undertaken to investigate the use of premixed O₂^{⋅-}/FAC stocks in multiple-dosing approaches. As observed for postmix treatment, 4×25 μM multiple-dose premix treatment yielded increased ∫₀^{t}[HO^{⋅}]dt and Δ[probe]/[probe]₀ compared to 1×100 μM single-dose premix treatment when H₂O₂/HO₂⁻ was quenched with catalase after each dosing step (FIG. 5). However, lower ∫₀^{t}[HO^{⋅}]dt and Δ[probe]/[probe]₀ were observed when H₂O₂/HO₂⁻ was not quenched after each dosing step (FIG. 5), likely due to HO^{⋅} scavenging by H₂O₂/HO₂⁻, as discussed in more detail below.

(v) Effects of [H₂O₂/HO₂⁻]₀

Due to HO₂^{⋅}/O₂^{⋅-} disproportionation (Eqs. 10-11), [H₂O₂/HO₂⁻] was always present in O₂^{⋅-} stocks. As H₂O₂/HO₂⁻ can scavenge HO^{⋅} (Eqs. 19-22) and RCS (Eqs. 30-31), it may in turn lower HO^{⋅} and RCS exposures during O₂^{⋅-}/FAC treatment.

| Cl^{•} + H₂O₂ → HO₂^{•} + Cl⁻ + H⁺ | k₁₈ = 2 × 10⁹ M⁻¹s⁻¹ | Equation |
|---|---|---|
| | | (30) |
| Cl₂^{•-} + H₂O₂ → HO₂^{•} + 2Cl⁻ + | k₁₉ ~10⁵-10⁶ M⁻¹s⁻¹ | Equation |
| H⁺ | | (31) |

To investigate this, probe degradation was examined during premix dosing of [HO₂^{⋅}/O₂^{⋅-}]₀/[FAC]₀=(200 μM)/(100 μM) to phosphate buffer pre-amended with varying [H₂O₂/HO₂⁻]₀. Measured HO^{⋅} and ClO^{⋅}/Cl₂^{⋅-} exposures were then examined versus total in situ concentrations, [H₂O₂/HO₂⁻]_{0.tot}, comprising the sum of pre-amended [H₂O₂/HO₂⁻]₀ plus [H₂O₂/HO₂⁻]₀ derived from the O₂^{⋅-}/FAC stock (Cl^{⋅} exposures were not included in this comparison, due to their large uncertainties). HO^{⋅} and ClO^{⋅}/Cl₂^{⋅-} exposures decreased linearly with increasing [H₂O₂/HO₂⁻]_{0.tot}, with a nearly constant ratio of ∫₀^{t}[HO^{⋅}]dt/∫₀^{t}[ClO^{⋅}/Cl₂^{⋅-}]dt ˜3.6-3.7 maintained over the range of [H₂O₂/HO₂⁻]_{0.tot} investigated. Extrapolation of the regression lines for ∫₀^{t}[HO^{⋅}]dt and ∫₀^{t}[ClO^{⋅}/Cl₂^{⋅-}]dt to [H₂O₂/HO₂⁻]_{0.tot}=0 indicates that in the absence of H₂O₂/HO₂⁻, the HO^{⋅} and ClO^{⋅}/Cl₂^{⋅-} exposures would be ˜10-20% higher than at the lowest [H₂O₂/HO₂⁻]_{0.tot} investigated (i.e., [H₂O₂/HO₂⁻]_{0.tot}˜700 μM, which represents H₂O₂/HO₂⁻ originating solely from the O₂^{⋅-} stock). These findings suggest that (a) minimizing H₂O₂/HO₂⁻ formation within O₂^{⋅-} stocks (which could also lead to improved stability of O₂^{⋅-}), and/or (b) undertaking O₂^{⋅-}/ FAC treatment at lower total [HO₂^{⋅}/O₂^{⋅-}]₀ (as discussed in section (iv)), may enable further increases in HO^{⋅} and RCS exposures and contaminant degradation.

### (vi) Effects of Dissolved Organic Matter (DOM) and Application to Natural Waters

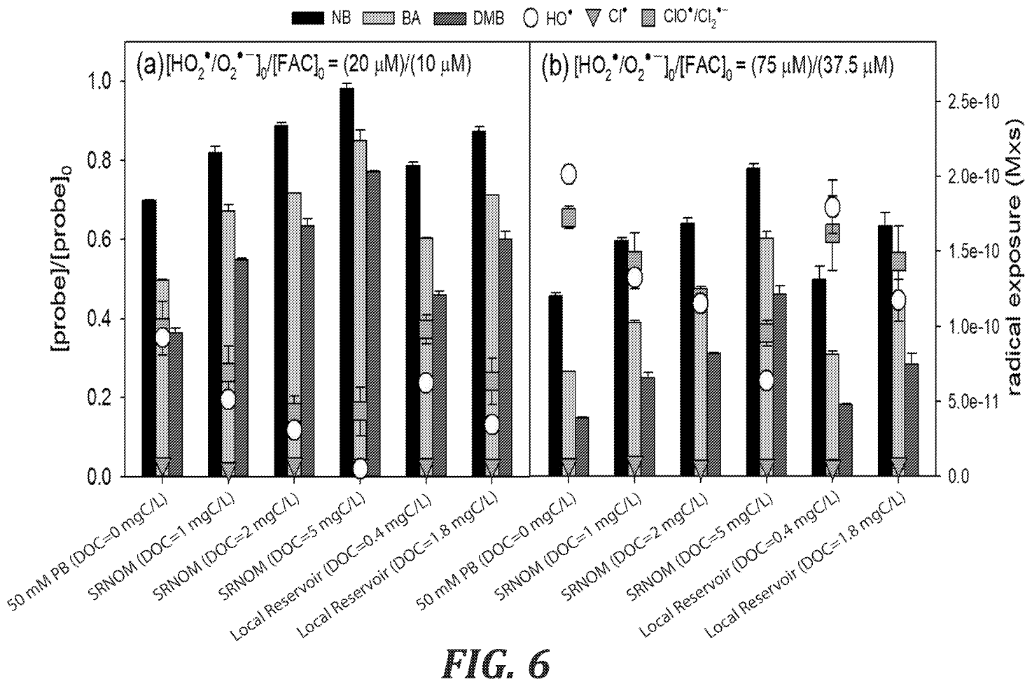

To investigate the influence of DOM on HO^{⋅} and RCS exposures, probe degradation was examined by premix dosing of O₂^{⋅-}/FAC to (a) phosphate buffer amended with varying concentrations of Suwannee River natural organic matter (SRNOM), and (b) two natural water samples collected from a Local Reservoir and Lake Washington. As shown in FIG. 6, radical exposures and Δ[probe]/[probe]₀ were greater at higher [HO₂^{⋅}/O₂^{⋅-}]₀ and [FAC]₀, but inhibited by increasing DOC concentrations. This is consistent with the anticipated scavenging of HO^{⋅}, Cl^{⋅}, ClO^{⋅}, and Cl₂^{⋅-} by DOM. Contributions of phosphate species to scavenging were negligible. Nevertheless, these findings demonstrate that relatively high HO^{⋅} and RCS exposures and contaminant degradation can still be achieved over DOC concentration ranges representative of drinking waters and potable reuse.

### Example 6

### Disinfection Byproduct (DBP) Formation

### (i) Oxyhalides

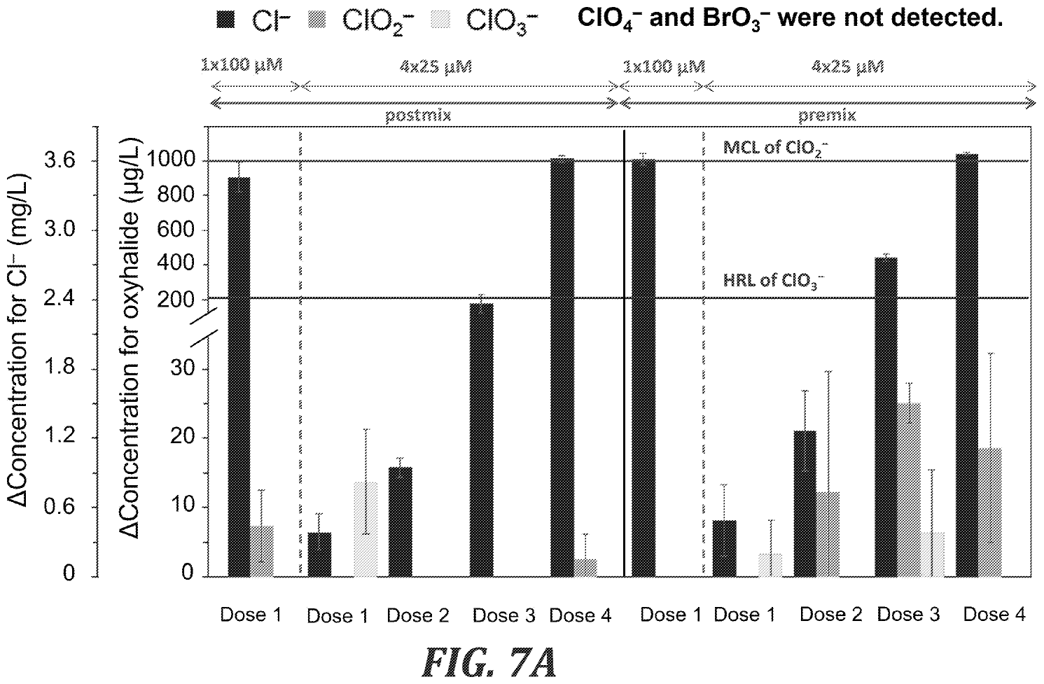

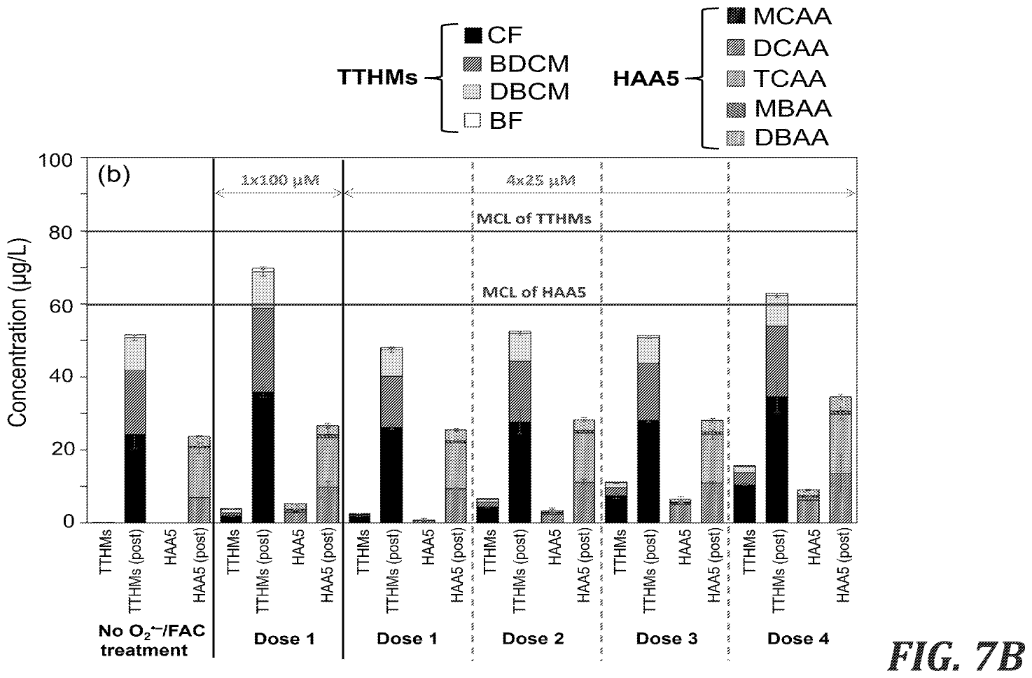

ClO₂⁻, ClO₃⁻, ClO₄⁻, and BrO₃⁻ were monitored in solutions containing 200 μgBr⁻/L during single- and multiple-dose postmix and premix O₂^{⋅-}/FAC treatment. As shown in FIGS. 7A and 7B, only ClO₂⁻ and ClO₃⁻ were formed in treated samples at concentrations above limits of quantification, and at no more than ˜25 μg/L. This is far below the maximum contaminant levels (MCLs) and health reference levels (HRLs) for ClO₂⁻ and ClO₃⁻ (note that concentrations in FIG. 7A have been corrected for background levels in FAC stocks). Relatively little difference was observed whether using postmix or premix treatment. Mass balances on concentrations of Cl⁻ formed in these samples confirmed that nearly all (>99.6%) of the FAC applied during O₂^{⋅-}/FAC treatment under these conditions reacts to Cl⁻, and that only traces of FAC are consumed via oxidation to higher oxidation states. This is further supported by the absence of detectable ClO₂ in O₂^{⋅-}/FAC treated solutions, which would be expected if substantial proportions of FAC were oxidized to ClO₂⁻ or higher states.

FIGS. 7A and 7B show concentrations of (a) oxyhalides and (b) THMs and HAAs resulting from single- and multiple-dose postmix and/or premix O₂^{⋅-}/FAC treatment. Oxyhalide formation experiments used alkaline O₂^{⋅-} stocks prepared from KO₂ in 0.1M NaOH (pH 13.0), with O₂^{⋅-}/FAC treatment either by adding O₂^{⋅-} to 5-mM, pH 7 phosphate buffer containing [FAC]₀=25 or 100 μM and [Br⁻]₀=200 μg/L (postmix), or by premixing alkaline O₂^{⋅-} with alkaline FAC (pH 13.0) and then adding the premixed O₂^{⋅-}/FAC stock to 5-mM, pH 7 phosphate buffer containing [Br⁻]₀=200 μg/L (premix). ΔConcentration=Concentrationₘₑₐₛ−Concentration_{stock}, where Concentrationₘₑₐₛ represents measured in situ concentration, and Concentration_{stock} represents background in situ concentration attributable to FAC stock (determined from controls prepared without O₂^{⋅-}/FAC treatment). THM/HAA formation experiments used alkaline O₂^{⋅-} stocks prepared from KO₂ in 1M NaOH (pH 13.9), with O₂^{⋅-}/FAC treatment by premixing alkaline O₂^{⋅-} with alkaline FAC (pH 13.9) and then adding the premixed O₂^{⋅-}/FAC stock to 50-mM, pH 7 phosphate buffer solutions containing 2 mgC/L of DOC (from SRNOM) and [Br⁻]₀=200 μg/L. O₂^{⋅-}/FAC-treated solutions were post-chlorinated at [FAC]₀=8 mgCl₂/L and allowed to react to CT_{FAC}=400 mgCl₂/L⋅min. Single-dose experiments were undertaken by dosing [HO₂^{⋅}/O₂^{⋅-}]₀/[FAC]₀=(200 μM)/(100 μM) once (1×100 μM), and multiple-dose experiments by dosing [HO₂^{⋅}/O₂^{⋅-}]₀/[FAC]₀=(50 μM)/(25 μM) four times (4×25 μM). Residual H₂O₂/HO₂⁻ was removed by catalase after each O₂^{⋅-} or O₂^{⋅-}/FAC dose, and residual FAC removed by excess Na₂S₂O₃ following post-chlorination. Error bars represent one std. dev. about the mean of duplicate measurements. HRL (health reference level) and MCL (maximum contaminant level) values are from the USEPA. Samples for organic DBPs were collected before and after post-chlorination. “(post)” in the x-axis for (b) indicates that samples were post-chlorinated after O₂^{⋅-}/FAC treatment.

### (ii) THMs and HAAs

Formation of trihalomethanes (THMs) and haloacetic acids (HAAs), two common groups of organic DBPs, was monitored in solutions containing 2 mgC/L of SRNOM and 200 μgBr⁻/L during (a) single- and multiple-dose premix O₂^{⋅-}/FAC treatment, and (b) following post-chlorination of the O₂^{⋅-}/FAC-treated samples to CT_{FAC}=400 mgCl₂/L⋅min. All O₂^{⋅-}/FAC-treated samples were separated into two sub-volumes: one for direct THM/HAA analyses, and the other for THM/HAA analyses after post-chlorination.

Results from these experiments, in addition to a control sample subjected to chlorination alone for comparison, are shown in FIG. 7B. Single- and multiple-dose O₂^{⋅-}/FAC treatment led to limited direct formation of TTHM or HAA5 (no more than ˜5-15 μg/L in either case). Following post-chlorination of O₂^{⋅-}/FAC-treated samples, concentrations reached ˜60-70 μg/L for TTHMs, and ˜25-35 μg/L for HAA5. In comparison, 52(±7) μg/L for TTHMs and 24(±2) μg/L for HAA5 was achieved in control samples subjected to chlorination alone (FIG. 7B). As shown in FIG. 7B, organic DBPs were collected before and after post-chlorination, wherein “(post)-” in the x-axis indicates the samples were post-chlorinated after O₂^{⋅-}/FAC treatment.

Notably, THM/HAA levels generated during multiple-dose O₂^{⋅-}/FAC treatment were higher than observed during single-dose treatment, with increasing levels formed during each dosing step in the multiple-dose experiments. This is consistent with the higher overall HO^{⋅} and RCS exposures observed during multiple-versus single-dose treatment (FIG. 5), and may be due in part to direct DOM halogenation by RCS, as reported in prior work on FAC-based AOPs. In contrast, higher TTHM levels following post-chlorination were observed in samples initially subjected to single-dose O₂^{⋅-}/FAC treatment. This latter observation may reflect a net increase of FAC-reactive THM precursor moieties in DOM (e.g., via HO^{⋅}− and/or RCS-driven hydroxylation of aromatic moieties) when subjected to the HO^{⋅} and RCS exposures prevailing during single-dose treatment. In contrast, the higher HO^{⋅} and RCS exposures prevailing during multiple-dose treatment may have led to more extensive DOM processing and a net decrease in FAC-reactive precursor moieties (e.g., via HO^{⋅}− and/or RCS-driven degradation of aromatic moieties via ring opening), as reported for various AOPs. Although neither TTHM nor HAA5 levels exceeded USEPA MCLs, these findings indicate the potential for increased THM/HAA formation in O₂^{⋅-}/FAC treatment, particularly following post-chlorination, and should be investigated further as part of continued research into potential applications of this approach for advanced oxidation.

### Example 7

### Refinement of O₂^{⋅-}/FAC Process for Practical Implications

A potential barrier to implementation of O₂^{⋅-}/FAC treatment derives from the high pH needed for O₂^{⋅-} stock solutions, and the consequent levels of acid necessary to neutralize the OH⁻ derived from the stock solutions upon dosing to receiving waters. Under the exploratory conditions used in many of the experiments described to this point, the use of high H₂SO₄ concentrations for NaOH neutralization would lead to levels of residual SO₄²⁻ in substantial excess of the USEPA secondary (non-enforceable) drinking water MCL of 250 mg/L as SO₄²⁻ in treated waters, potentially leading to negative aesthetic and/or gastrointestinal effects, or to enhanced risks of corrosion in materials in contact with treated waters. This issue can potentially be addressed by (1) preparing O₂^{⋅-} stocks in less alkaline NaOH solutions to decrease the H₂SO₄ concentration needed for neutralization, and/or (2) increasing the concentrations of O₂^{⋅-} in the stocks to enable the use of smaller stock volumes and higher dilution factors, which would also result in decreased H₂SO₄ requirements.

A series of additional experiments was therefore undertaken in which O₂^{⋅-} stocks were prepared from KO₂ or UV irradiation of H₂O₂/HO₂⁻ under conditions selected to achieve elevated [HO₂^{⋅}/O₂^{⋅-}] concentrations at lower pH, and used to degrade NB, BA, and DMB using single- and multiple-dose postmix O₂^{⋅-}/ FAC treatment (with H₂O₂ quenched using FAC in multiple-dosing). In so doing, it was found that for KO₂-derived O₂^{⋅-} stocks, the O₂^{⋅-}-yield and stability could be significantly improved by adding KO₂ solids slowly to NaOH solutions under rapid mixing, rather than by addition of NaOH to KO₂ solids, as was the case for most of the stocks prepared in this work (see Example 3). KO₂-derived stocks were in turn prepared from 20-mM KO₂ in 0.05M NaOH (pH 12.7), yielding concentrations of [HO₂^{⋅}/O₂^{⋅-}]_{stock}˜2 mM and [H₂O₂/HO₂⁻]_{stock}˜6 mM. UV-derived O₂^{⋅-} stocks were prepared using irradiation of 20 mM [H₂O₂/HO₂⁻]₀ in 0.05M NaOH (pH 12.7), yielding [HO₂^{⋅}/O₂^{⋅-}]_{stock}˜0.9 mM and [H₂O₂/HO₂⁻]_{stock}˜11 mM, or irradiation of 10 mM [H₂O₂/HO₂⁻]₀ in 0.0316M NaOH (pH 12.5), yielding [HO₂^{⋅}/O₂^{⋅-}]_{stock}˜0.5 mM and [H₂O₂/HO₂⁻]_{stock}˜5 mM.

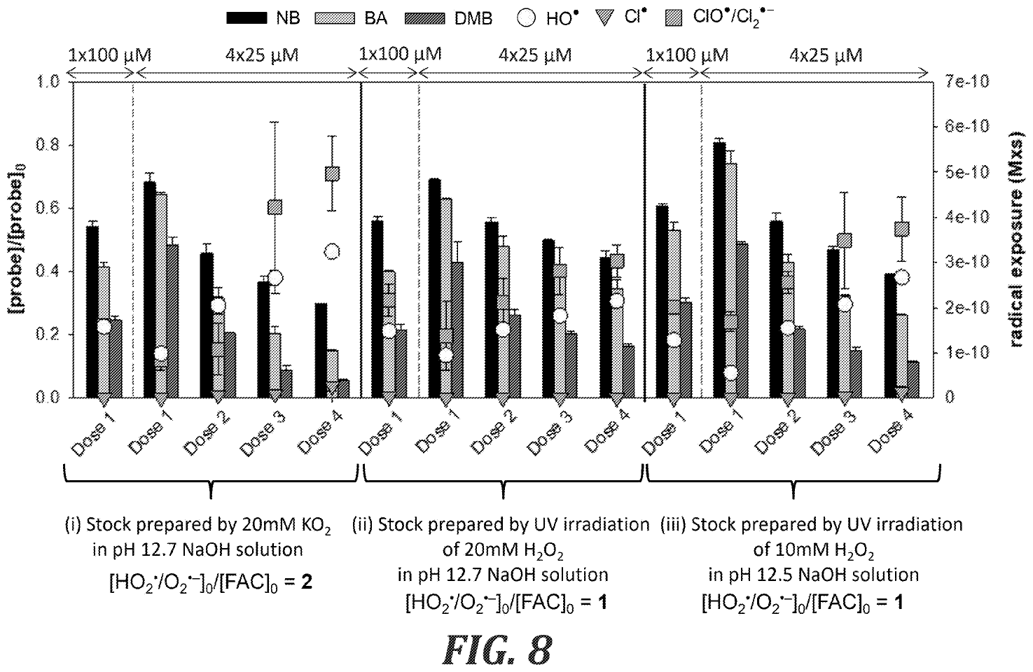

The KO₂-derived stocks were dosed to receiving solutions at [HO₂^{⋅}/O₂^{⋅-}]₀/[FAC]₀=2, with dilution factors ranging from 1:40 to 1:10, whereas the UV-derived stocks were dosed to receiving solutions at [HO₂^{⋅}/O₂^{⋅-}]₀/[FAC]₀=1 due to their lower [HO₂^{⋅}/O₂^{⋅-}]_{stock} concentrations, with dilution factors ranging from 1:40 to 1:5. As shown in FIG. 8, these experiments yielded levels of probe degradation comparable to those obtained using O₂^{⋅-} stocks prepared from KO₂ at higher pH (FIG. 5), with only moderately diminished effectiveness for the UV-derived stocks dosed at the lower [HO₂^{⋅}/O₂^{⋅-}]₀/[FAC]₀. At the same time, the use of the KO₂ stocks required only 2.5 mM of H₂SO₄ to neutralize OH⁻, resulting in residual SO₄²⁻ concentrations of 240 mg/L (below the secondary MCL). The use of the UV-derived stocks required only 2.8 and 3.2 mM of H₂SO₄ to neutralize OH⁻, resulting in residual SO₄²⁻ concentrations of 260 mg/L and 300 mg/L, respectively (just above the secondary MCL). Continued optimization of O₂^{⋅-} stock preparation and handling at lower pH values will be needed to enable further decreases in H₂SO₄ dosing requirements and consequent residual SO₄²⁻ concentrations. Residual [H₂O₂/HO₂⁻] levels in receiving solutions did not exceed ˜0.6 mM or -1.2 mM when using either KO₂-derived or UV-derived stocks, respectively. At these [H₂O₂/HO₂⁻] levels, the use of excess FAC to quench H₂O₂/HO₂⁻ in either single- or multiple-dosing approaches would be expected to contribute no more than ˜50 mg/L of total residual Cl⁻ to treated waters (assuming equimolar [Cl⁻] and [FAC] in FAC stocks and 100% conversion of FAC to Cl⁻ upon reaction with HO₂^{⋅}/O₂⁻ or H₂O₂/HO₂⁻), well below the secondary MCL of 250 mg/L as Cl⁻.

FIG. 8 shows modified O₂^{⋅-}/FAC treatment approaches using O₂^{⋅-} stock solutions generated at pH<13 by KO₂ dissolution or UV irradiation of H₂O₂/HO₂⁻ solutions, and dosed at [HO₂^{⋅}/O₂^{⋅-}]₀/[FAC]₀ ratios of 1 or 2. FIG. 8 also shows probe compound concentrations and in situ radical exposures (∫₀^{t}[radical]dt) resulting from multiple-dose postmix O₂^{⋅-}/FAC treatment of pH 7, 5mM phosphate buffer containing [NB, BA, DMB]₀=1 μM. In multiple-dose treatment, residual [H₂O₂/HO₂⁻] present after each O₂^{⋅-} dose (typically 0.15 mM-0.30 mM) was first measured by the Allen reagent method, after which sufficient FAC was added to scavenge all H₂O₂/HO₂⁻ and leave the desired [FAC] residual in solution for the following O₂^{⋅-} dose. O₂^{⋅-} stocks for dosing were prepared by (i) dissolution of KO₂ in 0.05M NaOH at pH 12.7, (ii) photolysis of H₂O₂/HO₂⁻ in 0.05M NaOH solutions at pH 12.7, or (iii) photolysis of H₂O₂/HO₂⁻ in 0.0316M NaOH solutions at pH 12.5 (see above for corresponding [HO₂^{⋅}/O₂^{⋅-}]_{stock} and [H₂O₂/HO₂⁻]_{stock} concentrations). For (i), experiments were undertaken by dosing [HO₂^{⋅}/O₂^{⋅-}]₀/[FAC]₀=(200 μM)/(100 μM) once (1×100 μM) or by dosing [HO₂^{⋅}/O₂^{⋅-}]₀[FAC]₀=(50 μM)/(25 μM) four times (4×25 μM). For (ii) and (iii), experiments were undertaken by dosing [HO₂^{⋅}/O₂^{⋅-}]₀/[FAC]₀=(100 μM)/(100 μM) once (1×100 μM) or by dosing [HO₂^{⋅}/O₂^{⋅-}]₀/[FAC]₀=(25 μM)/(25 μM) four times (4×25 μM). Error bars represent one standard deviation about the mean of duplicate measurements.

### Example 8

### Cost Estimation Based on Bench-Scale Treatment

UV-derived O₂^{⋅-} stocks may present a more practical option for implementing O₂^{⋅-}/FAC treatment at scale than use of KO₂ solids. For example, such stocks could be continuously generated on-site by using LP Hg or UV LED irradiation of alkaline H₂O₂/HO₂⁻ in a flow-through cell for online infusion into process waters. A preliminary estimate of the electrical and chemical costs for implementing such an approach was performed using data from the bench-scale experiments undertaken here with UV-derived O₂^{⋅-} stocks, with 90% degradation of BA in phosphate buffer during single-dose postmix treatment selected as a reference condition (with costs determined in units of $ per m³ of treated water per order of magnitude BA degradation, or $·m⁻³·order⁻¹). The resulting calculations yield a cost estimate of ˜$1.0-1.1·m⁻³·order⁻¹ for O₂^{⋅-}/FAC treatment (including costs for UV lamp output, H₂O₂, NaOH, H₂SO₄, and FAC). By comparison, the costs for O₃/H₂O₂ (including costs for O₃ generation and H₂O₂) and UV/H₂O₂ (including costs for UV lamp output and H₂O₂) to yield 90% degradation of the very structurally similar pCBA in various natural waters were estimated as $0.0043-0.008·m⁻³·order⁻¹ and $0.075-0.192·m⁻³·order⁻¹, respectively. It should be noted that these estimates do not account for variations in capital costs.

The ≥5-fold higher cost estimate for O₂^{⋅-}/FAC treatment primarily reflects costs of NaOH (˜50% of the total) and to a lesser extent H₂O₂ and FAC (˜31% of the total combined), followed by H₂SO₄ (˜6% of the total); the costs for UV lamp output (˜13% of the total) are similar to those for UV/H₂O₂. Further improvements in O₂^{⋅-}/FAC treatment performance and cost can likely be realized through continued refinement of approaches for O₂^{⋅-} stock preparation to improve HO₂^{⋅}/O₂^{⋅-} yield and stability at lower pH values. For example, if O₂^{⋅-} stock solution pH could be lowered by one unit (from 12.7 to 11.7) while still maintaining equivalent O₂^{⋅-} concentrations, NaOH and H₂SO₄ requirements could in turn be lowered by 10-fold, with a corresponding reduction of $0.57·m⁻³·order⁻¹ (or ˜50-60%) in overall costs. Alternatively, improvements in O₂^{⋅-} stability and/or yield from UV irradiation of alkaline H₂O₂/HO₂⁻ solutions at pH 12.7 (e.g., through the use of higher-intensity lamps or more efficient lamp geometries) could allow the accumulation of higher O₂^{⋅-} concentrations in stocks. This could in turn enable decreases in the required volumes of O₂^{⋅-} stock solutions to implement O₂^{⋅-}/FAC treatment at a given [HO₂⁻/O₂^{⋅-}]₀[FAC]₀ ratio, which would lead to lower NaOH, H₂O₂/HO₂⁻, and H₂SO₄ requirements. For example, a 2-fold increase in peak O₂^{⋅-} concentrations achievable in stocks could lead to a commensurate 2-fold decrease in O₂^{⋅-} stock volume requirements, in turn cutting NaOH, H₂O₂/HO₂⁻, and H₂SO₄ requirements in half and lowering the associated costs by $0.28·m⁻³·order⁻¹, 0.085·m⁻³·order⁻¹, and $0.035·m⁻³·order⁻¹ respectively (for a decrease of ˜35-45% in overall costs).

Even if $·m⁻³·order⁻¹ costs for O₂^{⋅-}/FAC treatment remain higher than for more conventional AOPs, its simplicity, rapid operational time-scales (and as a consequence, its low required reactor volume and footprint), potential for on-site O₂^{⋅-} generation, and widespread accessibility of FAC (also including potential for on-site generation) and other reagents could make this process uniquely advantageous for certain applications; in particular smaller-scale decentralized and/or point-of-use (waste)water treatment.

### Example 9

### Radical Exposure Levels and O₂^{⋅-}/FAC Stock Application

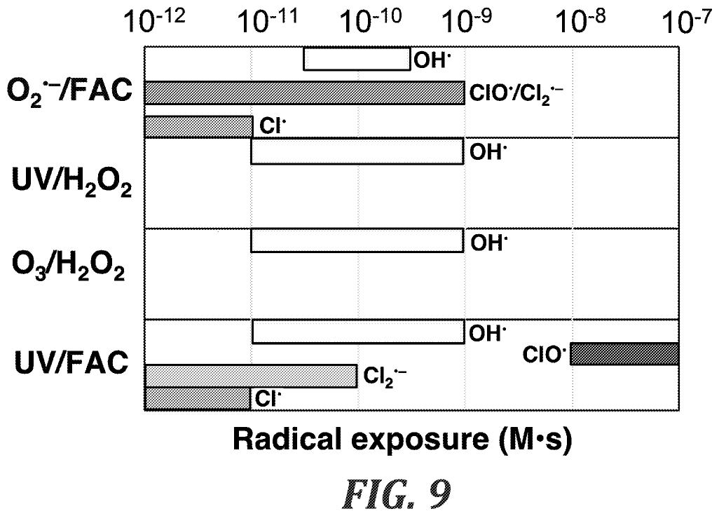

The O₂^{⋅-}/FAC reaction from Equation 1 is the basis for a novel, non-photochemical approach to advanced oxidation, with the capability to rapidly generate high HO^{⋅} and RCS levels for organic contaminant degradation at circumneutral pH and under homogenous conditions. The HO^{⋅} and RCS exposures achieved during O₂^{⋅-}/FAC treatment (up to ˜5×10⁻¹⁰ M×s for HO^{⋅}, ˜10⁻⁹ M×s for ClO^{⋅}/Cl₂^{⋅-}, and ˜10⁻¹¹ M×s for Cl^{⋅}) are comparable to or higher than those observed in several of the AOPs most commonly applied in water and wastewater treatment and reuse, including UV/H₂O₂ (˜10⁻¹¹-10⁻⁹ M×s for HO^{⋅}); O₃/H₂O₂ (˜10⁻¹¹-10⁻⁹ M×s for HO^{⋅}); and UV/FAC (˜10⁻¹¹-10⁻⁹, ˜10⁻⁸-10⁻⁶, ˜10⁻¹²-10⁻¹⁰, and ˜10⁻¹³-10⁻¹¹ M×s for HO^{⋅}, ClO^{⋅}, Cl₂^{⋅-}, and Cl^{⋅}, respectively), as seen in FIG. 9.

Preparing and standardizing aqueous O₂^{⋅-} stocks under conditions of enhanced HO₂^{⋅}/O₂^{⋅-} stability (pH>12) result in O₂^{⋅-} stocks which can be easily handled and dosed to receiving solutions already containing FAC. This provides the option of utilizing O₂^{⋅-}/FAC treatment as a means of generating a nearly instantaneous pulse (or multiple pulses) of HO^{⋅} and RCS in a post-oxidation process following pre-exposure to FAC for disinfection or pre-oxidation, in much the same way that O₃/H₂O₂ can be used to convert residual O₃ to HO^{⋅} following a prior period of O₃ exposure for disinfection or pre-oxidation.

Alternatively, pre-mixing of alkaline O₂^{⋅-} and FAC provides a unique option in which a combined O₂^{⋅-}/FAC stock can be added directly to a water at circumneutral pH to generate a pulse of HO^{⋅} and RCS for advanced oxidation, with the pre-mixed O₂^{⋅-}/FAC stock effectively serving as a ready-made HO^{⋅} and RCS stock. The use of such a pre-mixing approach also presents the opportunity to apply O₂^{⋅-}/FAC treatment without subjecting a water to pre-chlorination (with potential benefits for minimizing halogenated organic DBP formation), and may enable application to waters containing high levels of matrix constituents that would normally prevent maintenance of an FAC residual (e.g., NH₄⁺/NH₃).

Measurements of oxyhalide, THM, and HAA formation show that direct production of regulated DBPs is likely to be minimal during O₂^{⋅-}/FAC treatment. Although O₂^{⋅-}/FAC treatment does appear to lead to increased THM and HAA formation during post-chlorination (as might be the case if O₂^{⋅-}/FAC treatment is applied for pre-oxidation of water that is then subjected to FAC treatment for disinfection or distribution system residual maintenance), this is a trait shared by nearly all AOPs, and may be manageable by minimizing post-treatment FAC exposures, or by limiting treatment applications to waters containing low DOC concentrations.

### Example 10

### Full-Scale Implementation

Pilot- and/or full-scale water treatment plant implementation includes using multiple continuous stirred tank reactors (CSTRs) in series, which can be applied for multiple-dosing treatment, or using static mixers or venturi mixers inside a pipe, and with the reaction reagents infused at different locations of a pipeline for multiple-dosing applications.

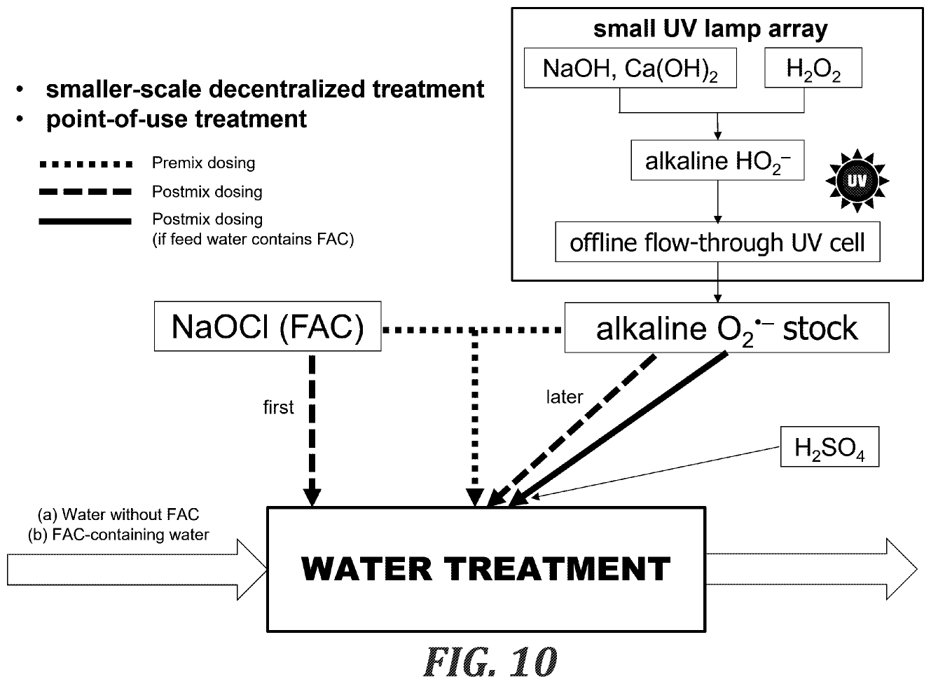

FIG. 10 shows a schematic for an apparatus implementing the O₂^{⋅-}/FAC process in water treatment. Alkaline H₂O₂ solutions can be prepared by the mixture of H₂O₂ with NaOH or Ca(OH)₂, and then subjected to UV irradiation to generate O₂^{⋅-} stock solutions. The resulting O₂^{⋅-} stocks can then be applied in three different scenarios, depending on the needs, including a premix dosing and postmix dosing.

For applications wherein the feed water already contains chlorine, then no chlorine or a lesser amount of chlorine would be required for the postmix dosing treatment. Such process only uses UV to produce O₂^{⋅-} stock in the presence of alkaline H₂O₂; UV is not involved in the AOP reactions. Compared to the conventional UV/H₂O₂ process which requires large and online UV irradiation of full treatment facilities, the O₂^{⋅-}/FAC process requires a very small-scale UV array for the side-stream O₂^{⋅-} stock preparation. As only a small volume needs to be irradiated, the O₂^{⋅-}/FAC process requires less associated capital costs and has less concern regarding UV light transmission limitations as compared to the conventional UV/H₂O₂ process. Although the process can be more expensive than other AOPs, the O₂^{⋅-}/FAC process can be applied on very small scale. which is a significant advantage for the process described herein.

### Example 11

### KrCl* Lamp (222 nm) for O₂^{⋅-} Stock Generation

Improving O₂^{⋅-} concentration and its stability in O₂^{⋅-} stock solutions can help reduce stock solution volumes needed for dosing during O₂^{⋅-}/FAC treatment, minimizing chemical costs. One example is to produce O₂^{⋅-} stocks through photochemical irradiation of alkaline H₂O₂ solution as heretofore described, but using higher-intensity lamps. Such a method can achieve higher O₂^{⋅-} yield in the stocks with more powerful UV254 lamps than the 5W low-pressure Hg lamp having fluence rate=39.5 mW/cm², as used in the Examples above.

However, more intensive UV254 radiation can self-limit O₂^{⋅-} accumulation in the stock, as it also facilitates O₂^{⋅-} photo-decomposition. One way to address this is switching to a wavelength that maximizes H₂O₂ photolysis while minimizing O₂^{⋅-} decomposition during irradiation. Emerging far-UVC devices (e.g., emitting UVC irradiation in the wavelength range of 220 to 225 nm), such as the krypton chloride (KrCl*) excimer lamp, present a good candidate option for this purpose.

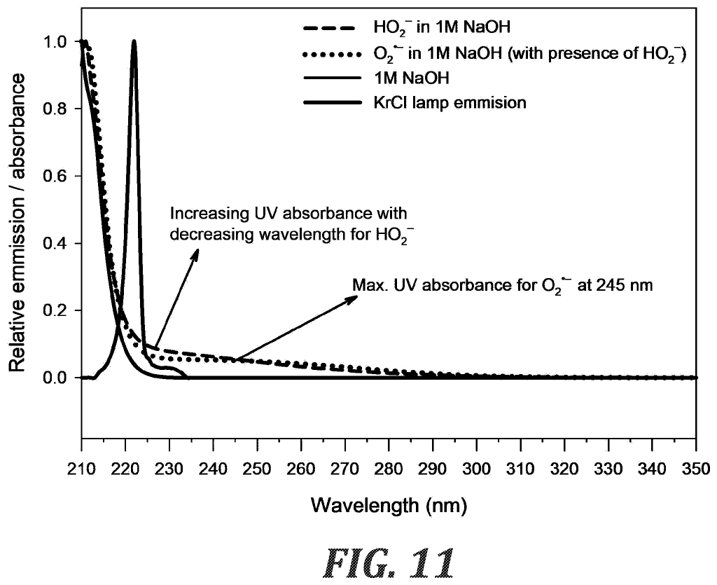

UV emission spectra for a KrCl* lamp, and absorbance spectra for H₂O₂ and O₂^{⋅-}, are shown in FIG. 11.

At pH ≥13, molar UV absorption coefficients of H₂O₂/HO₂⁻ (ϵ_{H}_{₂}_{^{O}}₂_{^{/HO}}₂_{^{−}}) are 539.4, 277.7, and 194.8 M⁻¹cm⁻¹ at 220, 250 and 260 nm, respectively. In contrast, HO₂^{⋅}/O₂^{⋅-} has molar absorption coefficients (ϵ_{HO}_{₂}_{^{⋅}}_{/O}_{₂}_{^{⋅−}}) of 1920, 2260, and 1940 M⁻¹cm⁻¹, at the same respective wavelengths. Molar absorption ratios of H₂O₂/HO₂⁻ relative to HO₂^{⋅}/O₂^{⋅-} are thus 0.281, 0.123, and 0.100 at the above three wavelengths, respectively. Therefore, irradiation at 220 nm more effectively photolyzes H₂O₂ while causing slower O₂^{⋅-} photolysis.

Moreover, far-UVC light has been reported to have low adverse effect on skin and eyes, and does not cause DNA damage in animals due to its very limited penetration into biological materials. Therefore, far-UVC light poses lower safety risks than light from UV254-emitting lamps.

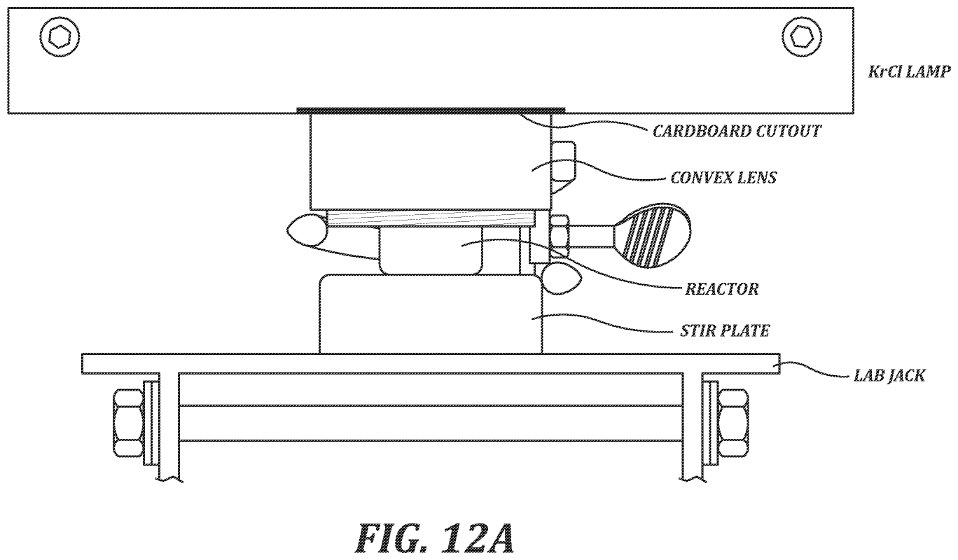

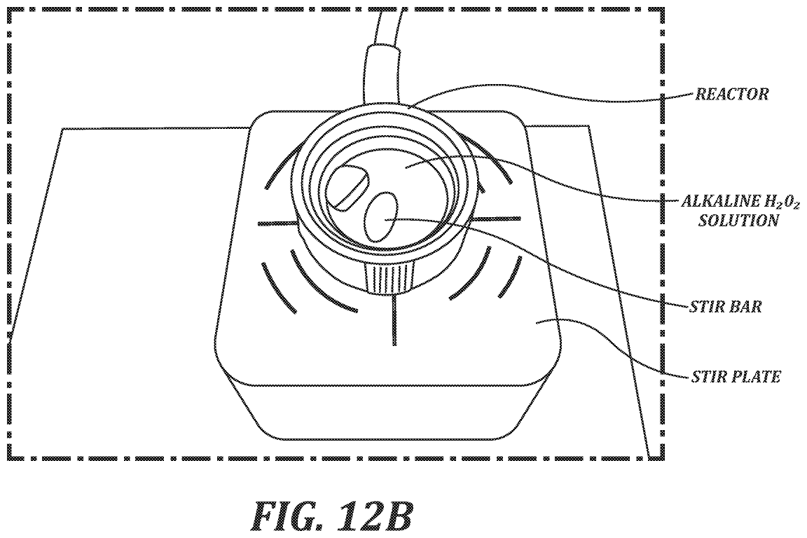

A KrCl* lamp emitting 222 nm UVC equipped with a 222-nm bandpass filter was consequently used to generate O₂^{⋅-} stock from alkaline H₂O₂ solution. The configuration and setup were as shown in FIGS. 12A and 12B. FIG. 12A, from top to bottom in order, shows a KrCl* lamp, a piece of cardboard with a circular cutout that matches the diameter of the lens immediately below, a plano convex lens (LA4464-ML, Thorlabs; convex side facing up and flat side facing down), a UV-resistant PTFE reactor with alkaline H₂O₂ solution and a micro magnetic stir bar, a magnetic stir plate, and a lab jack for adjusting the distance between the reactor and the light source. The convex lens was found to enhance the light intensity by around 15% compared to not having the lens installed. The fluence rate at the surface of the alkaline H₂O₂ solution (the point where the reactors receive irradiation) was measured to be 5.56 mW/cm².

Irradiation was initiated by placing a reactor containing 1, 0.1 or 0.05M NaOH and H₂O₂/HO₂⁻ at various initial concentrations in the path of the emitted light. The rim of the reactor was placed at the surface of the lens below the KrCl* lamp (222 nm, fluence rate=5.56 mW/cm²) for irradiation, with the contents continuously stirred by a magnetic stir bar at 200 rpm (FIG. 12B). At pre-defined times, the reactor was removed from the light, and samples were collected for spectrophotometric analyses of [HO₂^{⋅}/O₂^{⋅-}] and [H₂O₂/HO₂⁻]. For comparison, several tests using a low-pressure Hg lamp (254 nm, fluence rate=39.5 mW/cm²) were conducted by placing a quartz cuvette containing alkaline H₂O₂ solutions at the surface of the Hg lamp (as described above).

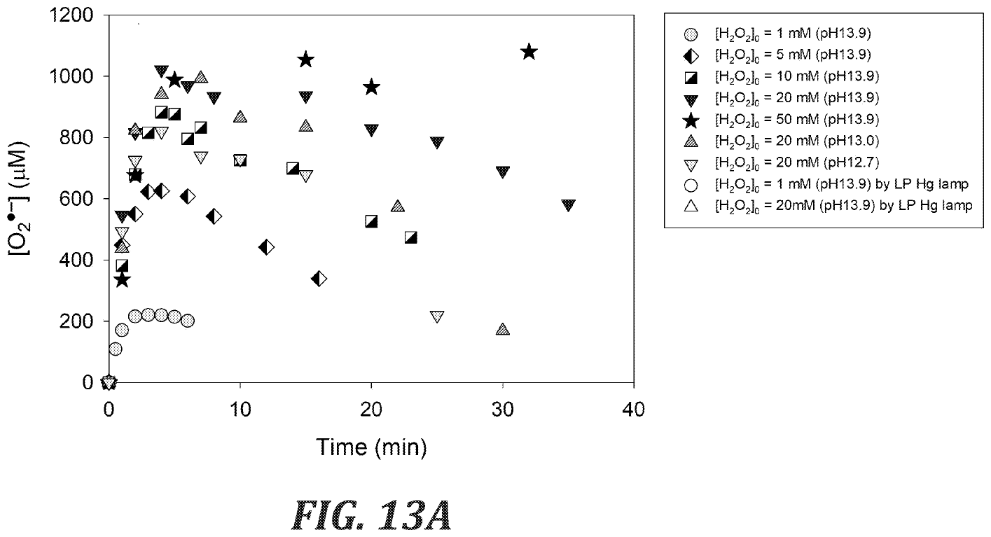

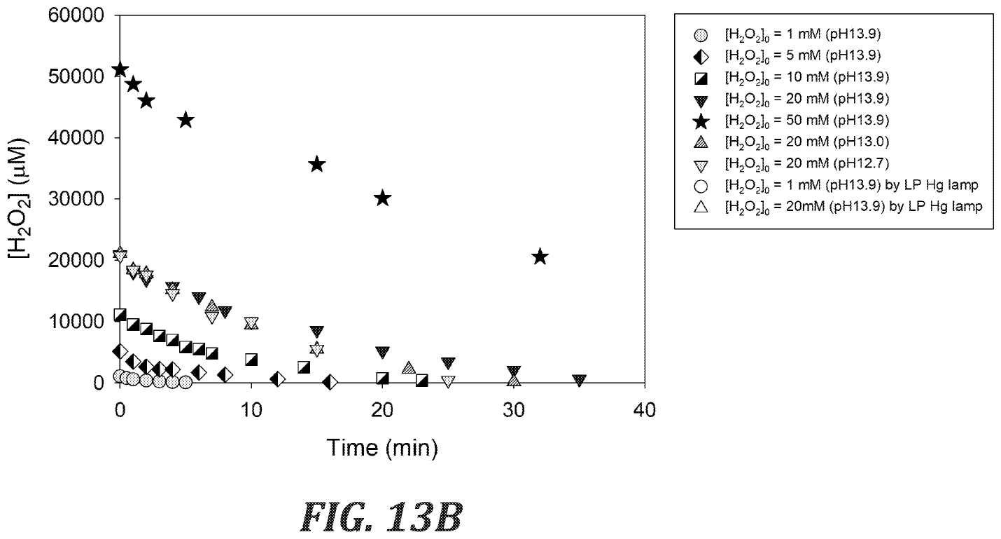

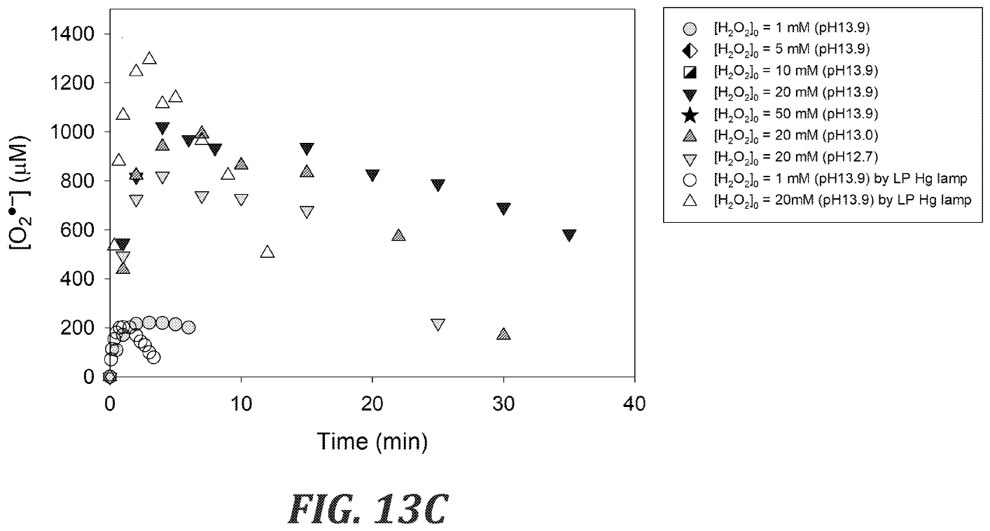

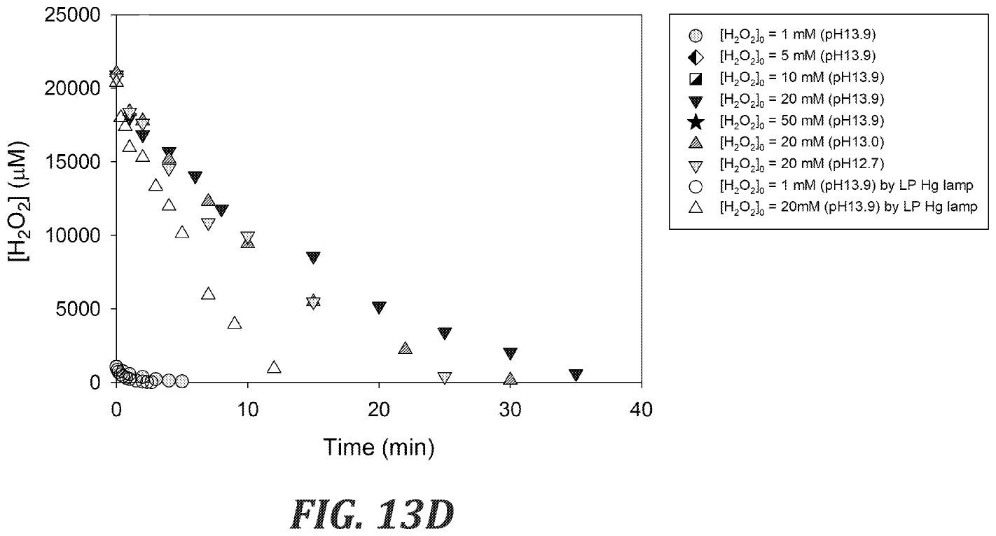

Irradiation at initial concentrations of H₂O₂/HO₂⁻ ranging from 1-20 mM resulted in the buildup of HO₂^{⋅}/O₂^{⋅-} over 2-5 minutes, to maximal HO₂^{⋅}/O₂^{⋅-} concentrations in 1, 0.1 and 0.05M NaOH solutions (FIGS. 13A-13D), with higher [H₂O₂/HO₂⁻]₀ yielding higher [HO₂^{⋅}/O₂^{⋅-}]. These values are in excess of the highest O₂^{⋅-} concentrations (˜400 μM) reported when using vacuum-UV photolysis of oxygenated aqueous ethanol and/or formate solutions, or UV photolysis of mixtures of ketones with alcohols.

Although the LP Hg lamp was able to generate a moderately higher maximal HO₂^{⋅}/O₂^{⋅-} concentration (˜1.3 mM from initial [H₂O₂/HO₂⁻]₀=20 mM), compared to the KrCl* lamp (˜1.0 mM under the same condition), HO₂^{⋅}/O₂^{⋅-} was less stable under the LP Hg lamp irradiation due to its higher emission intensity and the lower UV₂₅₄ absorption ratio of H₂O₂/HO₂⁻ relative to HO₂^{⋅}/O₂^{⋅-} (˜0.11), in comparison to UV₂₂₂ (0.281).

Furthermore, nearly “pure” O₂^{⋅-} stock solutions could be generated under extended irradiation when H₂O₂/HO₂⁻ was completely photolyzed while O₂^{⋅-} still remained in the stock. For example, 222-nm, 5.56 mW/cm² irradiation of a pH 13.9 [H₂O₂/HO₂⁻]=1 mM solution by the KrCl* lamp for 6 min generated a pure 200 μM O₂^{⋅-} stock. In contrast, a 254-nm, 39.5 mW/cm² irradiation of the same solution by the LP Hg lamp for 3 min produced a pure 100 μM O₂^{⋅-} stock (FIGS. 13A-13D). Therefore, a 222 nm-emitting KrCl* lamp could provide benefits over a 254 nm-emitting Hg lamp during O₂^{⋅-} stock generation in regard to (i) higher stability of O₂^{⋅-} in the stock, (ii) lower operation energy required, (iii) higher yield of pure O₂^{⋅-} stock in absence of H₂O₂/HO₂⁻, and (iv) lower safety risks.

### Example 12

### Comparison of O₂^{⋅-} Stock Preparation in Aqueous Solutions

Many of the previously-reported approaches for O₂^{⋅-} preparation require preparation of O₂^{⋅-} stock by dissolving superoxide salts in organic solvents like dimethylformamide (DMF) or dimethyl sulfoxide (DMSO). Such organic solvents or additives are incompatible with use of the resulting stock solutions in an AOP.

Limited options are available for preparing O₂^{⋅-} stocks in fully aqueous matrixes with high enough stabilities or at concentrations sufficient for use in water or wastewater treatment applications. Establishing O₂^{⋅-} preparation approaches in aqueous solutions is useful for applying the O₂^{⋅-}/FAC process in water treatment, since organic solvents or other organic additives can scavenge reactive/radical species being generated during the reactions, consequently reducing O₂^{⋅-}/FAC treatment efficiency.

Additionally, many previously-reported methods require specialized equipment.

While certain photochemical and KO₂ dissolution approaches have been reported to yield O₂^{⋅-} in fully aqueous solutions at pH≥11, the resulting concentrations are no greater than several hundred micromolar. Table A-1 shows a summary of and comparison of the maximal O₂^{⋅-} yields from the above processes.

Through the disclosure provided herein, the KO₂ dissolution method yielded O₂^{⋅-} in aqueous solutions at concentrations up to 3 mM when dosing 20 mM KO₂ salt in NaOH solution. In comparison, UV-photolysis of 20 mM alkaline H₂O₂ can generate maximum O₂^{⋅-} concentrations of 1.0 and 1.3 mM at pH 12.5 to 13.9 under 222 nm and 254 nm irradiation, respectively. As seen in Table A-1, the O₂^{⋅-} levels produced by the methods disclosed herein are three to four times higher than previous fully-aqueous, photochemical approaches.

TABLE A-1
Superoxide generation in aqueous solutions

| Generation | Light source | | | Maximum O₂^{•-} |
|---|---|---|---|---|
| method | (Wavelength) | Matrix | pH | concentration (μM) |
| KO₂ | Dark reaction | Aqueous NaOH | 12.5-13.9 | 3000 |
| dissolution | | solution | | (this disclosure) |
| KO₂ | Dark reaction | Aqueous NaOH | 12.7 | Not available (only |
| dissolution | | solution | | mean values of ~90 |
| | | | | μM reported) |
| UV | UV (254 nm) | Aqueous H₂O₂ | 12.5-13.9 | 1300 |
| photolysis | | solution | | (this disclosure) |
| UV | UV (222 nm) | Aqueous H₂O₂ | 12.7-13.9 | 1000 |
| photolysis | | solution | | (this disclosure) |
| UV | UV | Aqueous H₂O₂ | 13 | Not available |
| photolysis | | solution | | |
| UV | vacuum-UV | Aqueous ethanol | 12 | 350 |
| photolysis | (160-195 nm) | solution | | |
| UV | vacuum-UV | Formate in | 11-12 | 220 |
| photolysis | (160-185 nm) | oxygen-saturated | | |
| | | aqueous solution | | |
| UV | vacuum-UV | Ketones | 11-12.5 | 400 |
| photolysis | | (benzophenone, | | |
| | | acetophenone, or | | |
| | | acetone) in | | |
| | | oxygen-saturated | | |
| | | 2-propanol | | |
| | | aqueous solution | | |

The foregoing detailed description and examples have been given for clarity of understanding only. No unnecessary limitations are to be understood therefrom. The disclosure is not limited to the exact details shown and described, for variations obvious to one skilled in the art will be included within the invention defined by the claims. Accordingly, the invention is not limited except as by the claims.

The embodiments of the invention in which an exclusive property or privilege is claimed are defined as follows:

1. An advanced oxidation composition, comprising a superoxide radical stock solution and a free available chlorine solution,
wherein the superoxide radical stock solution comprises a superoxide radical, an aqueous medium, and a stabilizing agent,
wherein the superoxide radical in the superoxide radical stock solution has a concentration of about 300 μM to about 3 mM,
wherein the superoxide radical stock solution pH is about 11 to about 14, and
wherein the free available chlorine solution comprises a free available chlorine agent and an aqueous medium.

2. The advanced oxidation composition of claim 1, wherein the free available chlorine solution pH is about 11 to about 14, is about 6 to about 8, or is about 6 to about 8 and is buffered.

3. The advanced oxidation composition of claim 1, wherein the superoxide radical in the superoxide radical stock solution has a half-life of about 1 minute to about 5 minutes.

4. The advanced oxidation composition of claim 1, further comprising an acid.

5. The advanced oxidation composition of claim 1, wherein the superoxide radical stock solution is prepared from KO₂ by dissolving solid KO₂ in an alkaline aqueous medium, or by adding an alkaline aqueous medium to solid KO₂, to form a superoxide radical stock solution having a pH of about 11 to about 14.

6. The advanced oxidation composition of claim 1, wherein the superoxide radical stock solution is generated by irradiating hydrogen peroxide in an alkaline aqueous medium with ultraviolet irradiation, to form a superoxide radical stock solution having a pH of about 11 to about 14.

7. The advanced oxidation composition of claim 1, wherein the stabilizing agent comprises NaOH, KOH, Ca(OH)₂, a base which causes the pH to be higher than around 11, phosphate, EDTA, distilled water, decarbonation, or a combination thereof.

8. The advanced oxidation composition of claim 1, wherein the free available chlorine agent is sodium hypochlorite.

9. The advanced oxidation composition of claim 1, wherein the superoxide radical stock solution comprises the superoxide radical in an aqueous medium at a first concentration, wherein the free available chlorine solution comprises the free available chlorine in an aqueous medium at a second concentration, and wherein the ratio of the first concentration to the second concentration is about 0.2 to about 7.5.

10. The advanced oxidation composition of claim 1, wherein the superoxide radical stock solution comprises an amount of superoxide radical in an aqueous medium, wherein the free available chlorine solution comprises an amount of free available chlorine in an aqueous medium, and wherein an amount of free available chlorine is contacted by an amount of superoxide radical to produce a hydroxyl radical and one or more reactive chlorine species in an amount effective to degrade one or more chemical compound contaminants.

11. A method for advanced oxidation of chemical compound contaminants in a medium comprising one or more chemical compound contaminants, the method comprising contacting a medium comprising one or more chemical compound contaminants with the advanced oxidation composition according to claim 1,
wherein the medium comprising one or more chemical compound contaminants optionally comprises the free available chlorine solution prior to contact with the superoxide radical stock solution.

12. The method of claim 11, wherein the medium comprising the one or more chemical compound contaminants is contacted by the free available chlorine solution to form a mixture, wherein the free available chlorine solution has a pH of about 11 to about 14; and the mixture is simultaneously contacted by the superoxide radical stock solution and an acid, wherein the superoxide radical stock solution and the acid are not in contact with each other before contacting the mixture, and the simultaneous contact occurs with rapid mixing, to form the advanced oxidation composition at a pH of about 6 to about 8 in the medium comprising one or more chemical compound contaminants.

13. The method of claim 11, wherein the superoxide radical stock solution contacts the free available chlorine solution to form a premixed solution, wherein the free available chlorine has a pH of about 11 to about 14; and the premixed solution and an acid simultaneously contact the medium comprising one or more chemical compound contaminants, wherein the simultaneous contact occurs with rapid mixing, and the premixed solution and the acid are not in contact prior to contacting the medium comprising one or more chemical compound contaminants, to form an advanced oxidation composition having a pH of about 6 to about 8.

14. The method of claim 11, wherein the medium comprising one or more chemical compound contaminants comprises the free available chlorine solution; and the superoxide radical stock solution and an acid simultaneously contact the medium comprising the free available chlorine solution and the one or more chemical compound contaminants, wherein the superoxide radical stock solution and the acid are not in contact prior to contacting the medium comprising the free available chlorine solution and the one or more chemical compound contaminants, to form an advanced oxidation composition having a pH of about 6 to about 8.

15. The method of claim 11, wherein the medium comprising one or more chemical compound contaminants is contacted by the advanced oxidation composition one, or more than one, times.

16. The method of claim 11, further comprising a quenching step, wherein the quenching step comprises adding an amount of free available chlorine solution after contacting the medium comprising one or more chemical compound contaminants with the advanced oxidation composition.

17. The method of claim 11, wherein the medium comprising one or more chemical compound contaminants is municipal water, municipal wastewater, water centralized at a municipality, water localized at a point-of-use, well water, rain water, a natural body of water, water which has been treated, water which has not received a treatment, a microbe, a biofilm, an impermeable surface, a permeable surface, a detergent, or a combination thereof.

18. The method of claim 11, wherein the one or more chemical compound contaminants comprises a hydrocarbon comprising one or more saturated or unsaturated chemical bonds, or a chemical group which can be oxidized, and wherein the hydrocarbon or chemical group can further comprise atoms or functional groups which remain not oxidized.

19. An apparatus configured for advanced oxidation of one or more chemical compound contaminants in an aqueous medium comprising one or more chemical compound contaminants, the apparatus comprising:
one or more side-stream channels comprising an interior cavity configured for contact with a central contactor channel;
one or more inlet ports connected to the interior cavity of the one or more side-stream channels;
a central contactor channel in contact with more than one of the one or more side-stream channels, and which is configured to convey the aqueous medium comprising one or more chemical compound contaminants;
an ultraviolet source in contact with one of the one or more side-stream channels; and
a power source, and
wherein one of the one or more side-stream channels is configured to convey hydrogen peroxide in an alkaline aqueous medium at a pH of about 11 to about 14; a second of the one or more side-stream channels is configured to convey a free available chlorine solution comprising a free available chlorine formed from sodium hypochlorite and an alkaline aqueous medium at a pH of about 11 to about 14; a third of the one or more side-stream channels is configured to convey an acid; the hydrogen peroxide in alkaline aqueous medium transits the side-stream channel configured for hydrogen peroxide in alkaline aqueous medium by entry through one of the one or more inlet ports; the free available chlorine solution transits the side-stream channel configured for the free available chlorine solution by entry through one of the one or more inlet ports; the acid transits the side-stream channel configured for the acid by entry through one of the one or more inlet ports; a power source provides power to the ultraviolet source, wherein the ultraviolet source produces ultraviolet light; the hydrogen peroxide in alkaline aqueous medium is irradiated by the ultraviolet light to produce superoxide radical in a superoxide radical stock solution; the superoxide radical stock solution is optionally premixed with the free available chlorine solution by routing the superoxide radical stock solution and the free available chlorine solution through a mixing tee, to form a premixed solution comprising superoxide radical and free available chlorine, having a pH of about 11 to about 14; an aqueous medium flows through the central contactor channel configured to convey the aqueous medium comprising one or more chemical compound contaminants; the aqueous medium in the central contactor channel is contacted by the superoxide radical stock solution, the free available chlorine solution, and the acid, or is contacted by the premixed solution and the acid, wherein the aqueous medium is contacted by the superoxide radical stock solution, the free available chlorine solution, and the acid simultaneously under rapid mixing, or the aqueous medium is contacted by the premixed solution and the acid simultaneously under rapid mixing.

20. The apparatus of claim 19, wherein the apparatus is placed in series with one or more existing water treatment systems.
